(19) United States
(12) Patent Application Publication
(10) Pub. No.: US 2020/0023884 A1
(43) Pub. Date: Jan. 23, 2020

(54) DRIVING SUPPORT APPARATUS

(71) Applicants: TOYOTA JIDOSHA KABUSHIKI KAISHA, Toyota-shi (JP); DENSO CORPORATION, Kariya-city (JP)

(72) Inventors: Shun MIZOO, Zama-shi (JP); Yoji Kunihiro, Susono-shi (JP); Hisaya Akatsuka, Susono-shi (JP)

(73) Assignees: TOYOTA JIDOSHA KABUSHIKI KAISHA, Toyota-shi (JP); DENSO CORPORATION, Kariya-city (JP)

(21) Appl. No.: 16/514,411

(22) Filed: Jul. 17, 2019

(30) Foreign Application Priority Data
Jul. 18, 2018 (JP) 2018-135022

(51) Int. Cl. B62D 5/00; B62D 7/09; B62D 1/16; G08G 1/16; B62D 6/00; B60W 50/16; B60W 30/16; B60W 30/12; B60W 30/095; B60W 10/20; B60W 10/184

(52) U.S. Cl. CPC B62D 5/001; B62D 7/09; B62D 5/008; B62D 1/163; G08G 1/16; B60W 10/184; B60W 50/16; B60W 30/16; B60W 30/12; B60W 30/095; B60W 10/20; B62D 6/00

(57) ABSTRACT

Provided is a driving support apparatus configured to calculate a torque control amount based on at least a first steering control amount for causing an own vehicle to travel along a target travel line set in a travel lane and a second steering control amount for assisting an operation on a steering wheel by a driver, and drive a motor provided in a steering mechanism based on the torque control amount, the driving support apparatus being further configured to, when a predetermined condition is satisfied, correct the torque control amount.

### CLAIM OF PRIORITY

The present application claims priority from Japanese patent application JP 2018-135022 filed on Jul. 18, 2018, the content of which is hereby incorporated by reference into this application.

### BACKGROUND

### 1. Technical Field

The present disclosure relates to a driving support apparatus configured to execute lane trace control of supporting travel of a vehicle (own vehicle) close to a center of a lane.

### 2. Description of the Related Art

A driving support apparatus known hitherto is configured to acquire vehicle peripheral information on a peripheral state (such as partition lines and other vehicles) of a vehicle, and execute lane trace control so that the vehicle travels along a target travel line, which is set based on the vehicle peripheral information (for example, see Japanese Patent Application Laid-open No. 2017-035925).

In a vehicle provided with a steering mechanism configured to mechanically couple a steering wheel and wheels to each other, when a driver operates the steering wheel, one related-art driving support apparatus applies an assist torque to the steering mechanism so as to assist the operation of the driver. When the driver operates the steering wheel during the execution of the lane trace control in such a vehicle, the following problem occurs.

When the driver operates the steering wheel, the vehicle starts deviating from the target travel line. As a result, the driving support apparatus tries to return the vehicle to the target travel line thorough the lane trace control.

However, the operation on the steering wheel is assisted by the assist torque, and the driver may thus continue operating the steering wheel without feeling a sufficient reaction force. As a result, the vehicle may approach a partition line (white line) defining a travel lane to deviate from the travel lane. Therefore, a technology of notifying the driver of a possibility that the vehicle may deviate from the travel lane is required.

### SUMMARY

The present disclosure provides a driving support apparatus for a vehicle provided with a steering mechanism configured to mechanically couple a steering wheel and wheels to each other, the driving support apparatus being configured to use a steering torque to notify a driver of a possibility that the vehicle may deviate from a travel lane.

A driving support apparatus according to at least one embodiment (hereinafter sometimes referred to as “apparatus of at least one embodiment”) includes: a steering mechanism (60) configured to mechanically couple a steering wheel (SW) and a steered wheel (FWL, FWR) to each other; a motor (61), which is provided in the steering mechanism, and is configured to generate a torque for changing a steered angle of the steered wheel; an information acquisition device (16) configured to acquire vehicle peripheral information, the vehicle peripheral information including information on a partition line around an own vehicle and information on an object existing around the own vehicle; a first calculator (10, 510) configured to calculate a first steering control amount for causing the own vehicle to travel along a target travel line (TL) set in a travel lane, which is a lane in which the own vehicle is traveling, based on the vehicle peripheral information; a second calculator (10, 520) configured to calculate a second steering control amount for assisting an operation on the steering wheel by a driver in accordance with the operation on the steering wheel; and a steering controller (10, 40) configured to calculate a torque control amount (Trc) based on at least the first steering control amount and the second steering control amount, and drive the motor based on the torque control amount.

Further, the steering controller is configured to: determine, when the driver operates the steering wheel, whether a predetermined approach condition is satisfied based on at least the vehicle peripheral information, the predetermined approach condition being a condition which is satisfied when it is estimated that the own vehicle has approached any one of a partition line defining the travel lane and the object as a result of the operation on the steering wheel; and execute, when it is determined that the predetermined approach condition is satisfied, first correction control of correcting the torque control amount so that the torque control amount immediately after a first specific time point, at which it is determined that the predetermined approach condition is satisfied, becomes a value obtained by changing the torque control amount immediately before the first specific time point by a torque component in such a direction that the own vehicle approaches the target travel line (Step 1060, Step 1560, Step 1740, Step 2150).

With the apparatus of at least one embodiment, the torque control amount immediately after the first specific time point, at which the approach condition is satisfied, becomes equal to the value obtained by changing the torque control amount immediately before the first specific time point by the torque component in such a direction that the vehicle approaches the target travel line. As a result, a torque in a direction opposite to a direction of the operation on the steering wheel by the driver is generated on the steering wheel. Thus, the driver feels a reaction force against the own operation on the steering wheel. As described above, in the vehicle provided with the steering mechanism configured to mechanically couple the steering wheel and the wheels with each other, the apparatus of at least one embodiment can notify the driver of a possibility that the own vehicle deviates from the travel lane or the own vehicle may approach an object around the own vehicle through this reaction force. As a result, the driver can be prevented from operating the steering wheel further toward such a direction that the own vehicle approaches the partition line or the object.

In another aspect of the apparatus of at least one embodiment, the steering controller is configured to: determine whether the own vehicle is steered so that the own vehicle approaches any one of the partition line and the object after the execution of the first correction control is started; and stop the first correction control when it is determined that the own vehicle is not steered so as to approach any one of the partition line and the object (Step 1040: “No” and Step 1070; Step 1550: “No” and Step 1570; Step 1720: “No” and Step 1750; Step 2130: “No” and Step 2160).

For example, when the first correction control is continued under the state in which the driver is operating the steering wheel so as to return the own vehicle to the target travel line, the own vehicle is suddenly returned toward the target travel line, and the own vehicle may pass beyond the target travel line (that is, may overshoot the target travel lane). In contrast, the steering controller in this aspect stops the first correction control when it is determined that the own vehicle is not steered so as to approach the partition line or the object. As a result, the position of the own vehicle is gradually returned toward the target travel line. Thus, a possibility that the own vehicle may pass beyond the target travel line can be reduced.

In another aspect of the apparatus of at least one embodiment, the steering controller is configured to: determine whether or not the driver is operating the steering wheel after it is determined that the own vehicle is not steered so as to approach any one of the partition line and the object; execute, when it is determined that the driver is operating the steering wheel, second correction control so that a magnitude of the second steering control amount (Atr) at a second specific time point on and after it is determined that the driver is operating the steering wheel becomes a value larger than a magnitude of a basic assist control amount (Trb) corresponding to the operation on the steering wheel at the second specific time point (Step 1310: “Yes”, Step 1320); and stop the second correction control when it is determined that the driver is not operating the steering wheel after the second correction control is started (Step 1310: “No”, Step 1070).

In this aspect, when the own vehicle is not steered so as to approach the partition line or the object (that is, the own vehicle is steered so as to depart from the partition line or the object), and the driver is operating the steering wheel, the operation on the steering wheel by the driver is assisted through use of a large torque. As a result, the driver can return the position of the own vehicle to the target travel line with a smaller steering amount.

In another aspect of the apparatus of at least one embodiment, the steering controller is configured to execute the first correction control so that a magnitude of the second steering control amount (Atr) immediately after the first specific time point becomes smaller than a magnitude of the second steering control amount immediately before the first specific time point.

The steering controller in this aspect can generate a torque in the direction opposite to that of the operation by the driver by reducing the magnitude of the second steering control amount for assisting the operation on the steering wheel when the approach condition is satisfied. As a result, the driver feels a reaction force against the own operation on the steering wheel. The steering controller in this aspect can notify the driver of a possibility that the own vehicle may deviate from the travel lane or approaches an object around the own vehicle through this reaction force.

In another aspect of the apparatus of at least one embodiment, the steering controller is configured to execute the first correction control so that a magnitude of the first steering control amount (Ftr) immediately after the first specific time point becomes larger than a magnitude of the first steering control amount immediately before the first specific time point.

The steering controller in this aspect can generate a torque in the direction opposite to that of the operation on the steering wheel by the driver by increasing the magnitude of the first operation control amount for causing the own vehicle to travel along the target travel line when the approach condition is satisfied. As a result, the driver feels a reaction force against the own operation on the steering wheel. The steering controller in this aspect can notify the driver of a possibility that the own vehicle may deviate from the travel lane or approaches an object around the own vehicle through this reaction force.

In another aspect of the apparatus of at least one embodiment, the steering controller is configured to change a magnitude of the torque component in such a direction that the own vehicle approaches the target travel line in accordance with at least one of: a distance (dv1, dv2, dx1, dx2) between the own vehicle and any one of the partition line and the object; or a speed (Va1, Va2, Vb1, Vb2) at which the own vehicle approaches any one of the partition line and the object, to thereby execute the first correction control.

In this aspect, in accordance with at least one of: the distance between the own vehicle and any one of the partition line and the object; or the relative speed of the own vehicle with respect to any one of the partition line and the object, the magnitude of the torque component in such a direction that the own vehicle approaches the target travel line (that is, the torque component in the direction opposite to that of the operation by the driver) is changed. The steering controller in this aspect can thus notify the driver of a degree of the approach of the own vehicle to any one of the partition line and the object through the change in the magnitude of the torque component.

In the above description, in order to facilitate understanding of the present disclosure, names and/or reference symbols used in at least one embodiment of the present disclosure described later are enclosed in parentheses and are assigned to each of the constituent features corresponding to the at least one embodiment. However, each of the constituent features is not limited to the at least one embodiment defined by the names and/or reference symbols.

### BRIEF DESCRIPTION OF THE DRAWINGS

FIG. 1 is a schematic configuration diagram for illustrating a driving support apparatus according to a first embodiment.

FIG. 2 is a plan view for illustrating lane trace control using a target travel line determined based on a center line of a travel lane.

FIG. 3 is a plan view for illustrating lane trace control using a target travel line determined based on a preceding-vehicle trajectory.

FIG. 4 is a diagram for illustrating processing of correcting the preceding-vehicle trajectory of a preceding vehicle based on the center line of the travel lane.

FIG. 5 is a functional block diagram for illustrating a driving support ECU illustrated in FIG. 1.

FIG. 6 is a diagram for illustrating a first example of an operation of the driving support ECU in the first embodiment in a case where a vehicle deflects toward a left side with respect to a target travel line.

FIG. 7 is a diagram for illustrating a second example of the operation of the driving support ECU in the first embodiment in the case where the vehicle deflects toward the left side with respect to the target travel line.

FIG. 8 is a flowchart for illustrating an “LTC start/finish determination routine” to be executed by the driving support ECU in the first embodiment.

FIG. 9 is a flowchart for illustrating an “LTC execution routine” to be executed by the driving support ECU in the first embodiment.

FIG. 10 is a flowchart for illustrating an “assist torque calculation routine” to be executed by the driving support ECU in the first embodiment.

FIG. 11 is a flowchart for illustrating a “motor control routine” to be executed by the driving support ECU in the first embodiment.

FIG. 12 is a diagram for illustrating an example of an operation of a driving support ECU in a second embodiment in the case where the vehicle deflects toward the left side with respect to the target travel line.

FIG. 13 is a flowchart for illustrating an “assist torque calculation routine” to be executed by the driving support ECU in the second embodiment.

FIG. 14 is a diagram for illustrating an example of an operation of the driving support ECU in a third embodiment in a case where an own vehicle deflects toward the left side with respect to the target travel line under a state in which another vehicle is traveling in an adjacent lane.

FIG. 15 is a flowchart for illustrating an “assist torque calculation routine” to be executed by the driving support ECU in the third embodiment.

FIG. 16 is a functional block diagram for illustrating a driving support ECU in a fourth embodiment.

FIG. 17 is a flowchart for illustrating an “LTC execution routine” to be executed by the driving support ECU in the fourth embodiment.

FIG. 18 is a flowchart for illustrating a “motor control routine” to be executed by the driving support ECU in the fourth embodiment.

FIG. 19 is a functional block diagram for illustrating a driving support ECU in a fifth embodiment.

FIG. 20A is a graph for showing an example of a lookup table to be used by the driving support ECU in the fifth embodiment.

FIG. 20B is a graph for showing an example of a lookup table to be used by the driving support ECU in the fifth embodiment.

FIG. 21 is a flowchart for illustrating an “assist torque/correction torque calculation routine” to be executed by the driving support ECU in the fifth embodiment.

FIG. 22 is a flowchart for illustrating a “motor control routine” to be executed by the driving support ECU in the fifth embodiment.

FIG. 23A is a graph for showing an example of a lookup table to be used by a driving support ECU in a modification example.

FIG. 23B is a graph for showing an example of a lookup table to be used by a driving support ECU in a modification example.

FIG. 23C is a graph for showing an example of a lookup table to be used by a driving support ECU in a modification example.

FIG. 24 is a graph for showing an example of a lookup table to be used by the driving support ECU in another modification example.

### DESCRIPTION OF THE EMBODIMENTS

Now, referring to the accompanying drawings, a description is given of one or more embodiments of the present disclosure. The accompanying drawings are illustrations of specific embodiments, but those illustrations are examples to be used for the understanding of the present disclosure, and are not to be used to limit the interpretation of the present disclosure.

### First Embodiment

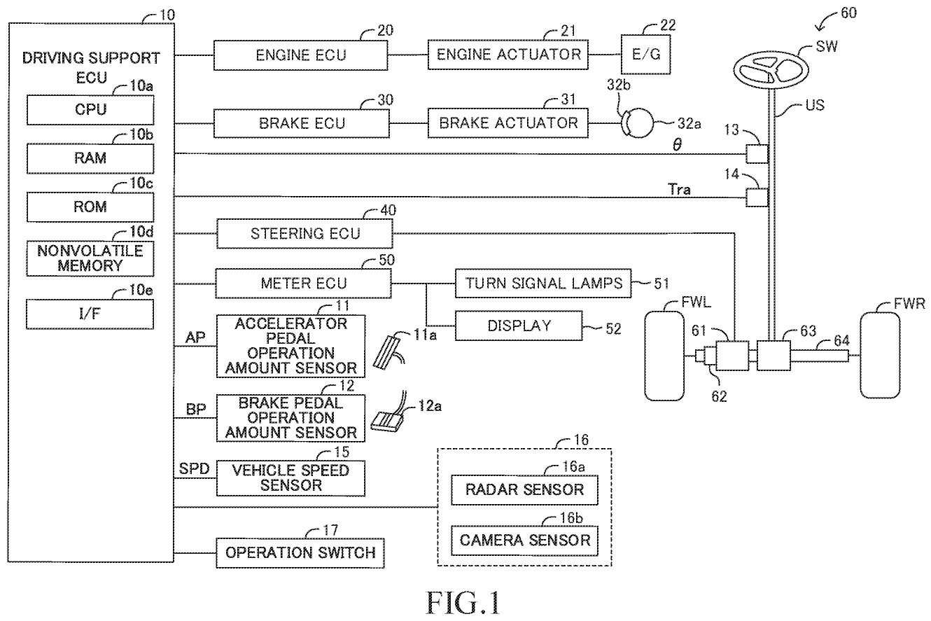

A driving support apparatus according to a first embodiment (hereinafter sometimes referred to as “first apparatus”) is applied to a vehicle (motor vehicle). The vehicle to which the first apparatus is applied is sometimes referred to as “own vehicle” so as to be distinguished from other vehicles. As illustrated in FIG. 1, the driving support apparatus includes a driving support ECU 10, an engine ECU 20, a brake ECU 30, a steering ECU 40, and a meter ECU 50.

Those ECUs are electric control units each including a microcomputer as a main part, and are connected to one another so as to be able to mutually transmit and receive information via a controller area network (CAN) (not shown). The microcomputer herein includes a CPU, a RAM, a ROM, an interface I/F, and the like. The CPU executes instructions (programs and routines) stored in the ROM, to thereby implement various functions. For example, the driving support ECU 10 includes a microcomputer including a CPU 10a, a RAM 10b, a ROM 10c, a nonvolatile memory 10d, an interface (I/F) 10e, and the like.

The driving support ECU 10 is connected to sensors (including switches) listed below, and is configured to receive detection signals or output signals from those sensors. Alternatively, each sensor may be connected to an ECU other than the driving support ECU 10. In this case, the driving support ECU 10 receives the detection signal or the output signal of the sensor from the ECU to which the sensor is connected via the CAN.

An accelerator pedal operation amount sensor 11 is configured to detect an operation amount (accelerator opening degree) of an accelerator pedal 11a of the own vehicle, and output a signal representing an accelerator pedal operation amount AP.

A brake pedal operation amount sensor 12 is configured to detect an operation amount of a brake pedal 12a of the own vehicle, and output a signal representing a brake pedal operation amount BP.

A steering angle sensor 13 is configured to detect a steering angle of the own vehicle, and output a signal representing a steering angle θ. The steering angle θ has a positive value when a steering wheel SW is rotated toward a first direction (left direction) from a predetermined reference position (neutral position), and has a negative value when the steering wheel SW is rotated toward a second direction (right direction) opposite to the first direction from the predetermined reference position. The neutral position is a position at which the steering angle θ is zero, and is thus a position of the steering wheel SW at a time when the vehicle travels straight. Further, the driving support ECU 10 is configured to calculate a steering angular velocity (θ′) from the steering angle θ received from the steering angle sensor 13.

A steering torque sensor 14 is configured to detect a steering torque applied to a steering shaft US of the own vehicle by the operation of the steering wheel SW, and output a signal representing a steering torque Tra. The steering torque Tra has a positive value when the steering wheel SW is rotated toward the first direction (left direction), and has a negative value when the steering wheel SW is rotated toward the second direction (right direction)

A vehicle speed sensor 15 is configured to detect a travel speed (vehicle speed) of the own vehicle, and output a signal representing a vehicle speed SPD.

The ambient sensor 16 is configured to acquire information on a road (including a travel lane in which the own vehicle is traveling and adjacent lanes adjacent to the travel lane) around the own vehicle and information on 3D objects existing on the road. The 3D object means a moving object, for example, a motor vehicle, a pedestrian, or a bicycle, or a fixed object, for example, a guard rail or a fence. Those 3D objects are hereinafter also referred to as “objects”. The ambient sensor 16 includes a radar sensor 16a and a camera sensor 16b.

The radar sensor 16a is configured to radiate, for example, a radio wave in a millimeter wave band (hereinafter referred to as “millimeter wave”) to a peripheral region of the own vehicle including at least a region ahead of the own vehicle, and receive a millimeter wave (namely, a reflected wave) reflected by an object existing in the radiation range. Further, the radar sensor 16a is configured to determine whether or not an object exists, and calculate and output parameters indicating a relative relationship between the own vehicle and the object. The parameters indicating the relative relationship between the own vehicle and the object include a position of the object with respect to the own vehicle, a distance between the own vehicle and the object, a relative speed between the own vehicle and the object, and other such parameters.

More specifically, the radar sensor 16a includes a millimeter wave transmission/reception module and a processing module. The processing module obtains, each time a predetermined period elapses, the parameters indicating the relative relationship between the own vehicle and the object based on a phase difference between the millimeter wave transmitted from the millimeter wave transmission/reception module and a reflected wave received by the millimeter wave transmission/reception module, an attenuation level of the reflected wave, a period from the transmission of the millimeter wave to the reception of the reflected wave, and other such information. Those parameters contain an inter-vehicle distance (longitudinal distance) Dfx(n), a relative speed Vfx(n), a lateral distance Dfy(n), and a relative lateral speed Vfy(n) with respect to each detected object(n).

The inter-vehicle distance Dfx(n) is a distance between the own vehicle and the object(n) (e.g., a preceding vehicle) along a center axis of the own vehicle (a center axis extending in a front-rear direction of the own vehicle, namely, an x axis described later).

The relative speed Vfx(n) is a difference (=Vs−Vj) between a speed Vs of the object(n) (e.g., a preceding vehicle) and a speed Vj of the own vehicle. The speed Vs of the object(n) is a speed of the object(n) in a travel direction of the own vehicle (namely, the direction of the x axis described later).

The lateral distance Dfy(n) is a distance of a “center position of the object(n) (e.g., a center position in a vehicle widthwise direction of a preceding vehicle)” from the center axis of the own vehicle in a direction orthogonal to the center axis of the own vehicle (namely, a direction of a y axis described later). The lateral distance Dfy(n) is also referred to as “lateral position”.

The relative lateral speed Vfy(n) is a speed of the center position of the object(n) (e.g., the center position in the vehicle widthwise direction of a preceding vehicle) in the direction orthogonal to the center axis of the own vehicle (namely, the direction of the y axis described later).

The camera sensor 16b includes a stereo camera and an image processor, and takes images of scenes in a left-side region and a right-side region forward of the vehicle to acquire a pair of left and right pieces of image data. The camera sensor 16b is configured to determine whether or not an object exists based on the pair of left and right pieces of taken image data, calculate parameters indicating the relative relationship between the own vehicle and the object, and output a determination result and a calculation result. In this case, the driving support ECU 10 combines parameters indicating the relative relationship between the own vehicle and the object obtained by the radar sensor 16a and parameters indicating the relative relationship between the own vehicle and the object obtained by the camera sensor 16b with each other, to thereby determine the parameters indicating the relative relationship between the own vehicle and the object.

Further, the camera sensor 16b recognizes left and right partition lines of the road (travel lane in which the own vehicle is traveling) based on the pair of left and right pieces of image data taken by the camera sensor 16b, and calculates shapes (for example, a curvature of the road) of the road and a positional relationship (for example, a distance from a left end or a right end of the lane in which the own vehicle is traveling to a center position of the own vehicle in a vehicle widthwise direction) between the road and the own vehicle. Information on the lane including the shapes of the road, the positional relationship between the road and the own vehicle, and the like is referred to as “lane information”. The camera sensor 16b outputs the calculated lane information to the driving support ECU 10. The partition line includes a white line and a yellow line, but the following description is given assuming that the partition line is the white line.

Information on an object (including parameters indicating the relative relationship between the own vehicle and the object) acquired by the ambient sensor 16 is referred to as “object information”. The ambient sensor 16 repeatedly transmits the object information to the driving support ECU 10 each time a predetermined sampling period elapses. The driving support ECU 10 acquires information on a peripheral state of the vehicle including “object information and lane information” as “vehicle peripheral information”.

The ambient sensor 16 is not always required to include both the radar sensor and the camera sensor, and may include, for example, only the camera sensor. The ambient sensor 16 is sometimes referred to as “information acquisition module (information acquisition device) configured to acquire the vehicle peripheral information”.

An operation switch 17 is a switch to be operated by the driver. The driver can operate the operation switch 17 to select whether or not to execute adaptive cruise control described later. Further, the driver can operate the operation switch 17 to select whether or not to execute lane trace control described later.

The engine ECU 20 is connected to an engine actuator 21. The engine actuator 21 includes a throttle valve actuator configured to change an opening degree of a throttle valve of an internal combustion engine 22. The engine ECU 20 can drive the engine actuator 21 to change a torque generated by the internal combustion engine 22. The torque generated by the internal combustion engine 22 is transmitted to drive wheels (not shown) via a transmission (not shown). Thus, the engine ECU 20 can control the engine actuator 21 to control a driving force of the own vehicle, to thereby change an acceleration state (acceleration). When the own vehicle is a hybrid vehicle, the engine ECU 20 can control a driving force of the own vehicle generated by any one of or both of an “internal combustion engine and electric motor” serving as vehicle driving sources. When the own vehicle is an electric vehicle, the engine ECU 20 can control a driving force of the own vehicle generated by an electric motor serving as a vehicle driving source.

The brake ECU 30 is connected to a brake actuator 31. The brake actuator 31 is provided in a hydraulic circuit between a master cylinder (not shown) configured to pressurize a working fluid with a stepping force on a brake pedal 12a and friction brake mechanisms 32 provided on the front/rear left/right wheels. The brake actuator 31 adjusts a hydraulic pressure of the working fluid to be supplied to a wheel cylinder integrated into a brake caliper 32b of the friction brake mechanism 32 in accordance with an instruction from the brake ECU 30. With the wheel cylinder being operated by the hydraulic pressure, a brake pad is pressed against a brake disc 32a to generate a friction braking force. Thus, the brake ECU 30 can control the brake actuator 31 to control the braking force of the own vehicle and change an acceleration state (a deceleration, namely, a negative acceleration) of the own vehicle.

The steering ECU 40 is a control apparatus for a widely-known electric power steering system, and is connected to a motor 61 built into a steering mechanism 60. The steering mechanism 60 is a mechanism configured to steer a left front wheel FWL and a right front wheel FWR by a rotation operation on the steering wheel SW. The steering wheel SW is rotatably connected to one end of the steering shaft US. A pinion gear 63 is rotatably connected to the other end of the steering shaft US. Thus, the pinion gear 63 is configured to rotate through the rotation of the steering wheel SW. The steering shaft US actually includes an upper shaft, an intermediate shaft, and a lower shaft coupled to one another so as to be capable of transmitting a torque.

The pinion gear 63 meshes with a rack gear (not shown) formed on a rack bar 64. The pinion gear 63 and the rack bar 64 form a rack-and-pinion mechanism. A rotational motion of the pinion gear 63 is converted to a reciprocal linear motion of the rack bar 64 by this rack-and-pinion mechanism. Respective steered wheels (the left front wheel FWL and the right front wheel FWR) are connected to both ends of the rack bar 64 through tie rods (not shown) so as to be capable of being steered. The steering wheel SW and the wheels (steered wheels) are mechanically coupled to each other in such a manner. Steered angles of the steered wheels (the left front wheel FWL and the right front wheel FWR) are changed in accordance with the reciprocal linear motion of the rack bar 64. That is, as the steering wheel SW rotates, the steered angles of the steered wheels (the left front wheel FWL and the right front wheel FWR) are changed.

The motor 61 is mounted to the rack bar 64 through a conversion mechanism 62. The conversion mechanism 62 includes a speed reducer (not shown). The conversion mechanism 62 is configured to reduce a speed of the rotation of the motor 61, and covert a rotational torque of the motor 61 to the linear motion, to thereby transmit the linear motion to the rack bar 64. In such a manner, the motor 61 is configured to generate such a torque to change the steered angles of the steered wheels (the left front wheel FWL and the right front wheel FWR).

The driving support ECU 10 is configured to calculate an assist torque in accordance with the operation on the steering wheel SW by the driver based on the steering torque Tra, the vehicle speed SPD, and the like, and output the assist torque to the steering ECU 40. The steering ECU 40 calculates a value of current caused to flow through the motor 61 (a current value that provides the assist torque) based on the assist torque, and controls the motor 61 so that current having the current value flows. In such a manner, the steering ECU 40 generates in the motor 61 the assist torque (assist force) to be generated when the driver operates the steering wheel SW.

The meter ECU 50 is connected to left and right turn signal lamps 51 (blinker lamps) and a display 52. The meter ECU 50 is configured to flash the left or right turn signal lamp 51 through a blinker drive circuit (not shown). The display 52 is a multi-information display provided in front of a driver's seat. The display 52 displays measurement values such as the vehicle speed and an engine rotation speed as well as various types of information.

A description is now given of an overview of an operation of the driving support ECU 10. The driving support ECU 10 can execute the “adaptive cruise control” and the “lane trace control”.

<Adaptive Cruise Control (ACC)>

The adaptive cruise control is control of causing the own vehicle to follow a preceding vehicle (ACC following target vehicle described later) traveling immediately ahead of the own vehicle in a region ahead of the own vehicle while maintaining a distance between the own vehicle and the preceding vehicle to be a predetermined distance based on the object information. The ACC itself is widely known (see, for example, Japanese Patent Application Laid-open No. 2014-148293, Japanese Patent Application Laid-open No. 2006-315491, Japanese Patent No. 4172434, and Japanese Patent No. 4929777). Thus, a brief description is now given of the ACC.

The driving support ECU 10 executes the adaptive cruise control when the adaptive cruise control is requested by the operation on the operation switch 17.

More specifically, when the adaptive cruise control is requested, the driving support ECU 10 selects an ACC following target vehicle based on the object information acquired by the ambient sensor 16. For example, the driving support ECU 10 determines whether or not a relative position of a detected object (n) identified by the lateral distance Dfy(n) and the inter-vehicle distance Dfx(n) of the object (n) exists in a following-target-vehicle area. The following-target-vehicle area is an area defined in advance so that an absolute value of a distance in a lateral direction with respect to the travel direction of the own vehicle, which is estimated based on the vehicle speed of the own vehicle and the yaw rate of the own vehicle, decreases as a distance in the travel direction increases. Then, the driving support ECU 10 selects the object(n) as the ACC following target vehicle when the relative position of the object(n) exists in the following-target-vehicle area for a predetermined period or longer. When there are a plurality of objects for which the relative position exists in the following-target-vehicle area for the predetermined period or longer, the driving support ECU 10 selects an object having the shortest inter-vehicle distance Dfx(n) from among those objects as the ACC following target vehicle.

Further, the driving support ECU 10 calculates a target acceleration Gtgt in accordance with any one of Expression (1) and Expression (2) given below. In Expression (1) and Expression (2), Vfx(a) represents a relative speed of an ACC following target vehicle (a), k1 and k2 represent predetermined positive gains (coefficients), and ΔD1 represents an inter-vehicle distance difference (=Dfx(a)−Dtgt) obtained by subtracting a “target inter-vehicle distance Dtgt” from an “inter-vehicle distance Dfx(a) of the ACC following target vehicle (a)”. The target inter-vehicle distance Dtgt is calculated by multiplying a target inter-vehicle period Ttgt set by the driver using the operation switch 17 by the vehicle speed SPD of the own vehicle 100 (that is, Dtgt=Ttgt·SPD).

The driving support ECU 10 uses Expression (1) given below to determine the target acceleration Gtgt when the value (k1·ΔD1+k2·Vfx(a)) is positive or “0”. ka1 represents a positive gain (coefficient) for acceleration, and is set to a value equal to or smaller than “1”.

The driving support ECU 10 uses Expression (2) given below to determine the target acceleration Gtgt when the value (k1·ΔD1+k2·Vfx(a)) is negative. kd1 represents a positive gain (coefficient) for deceleration, and is set to “1” in this example.

Gtgt (for acceleration)=ka1·(k1·ΔD1+k2·Vfx(a)) (1)

Gtgt (for deceleration)=kd1·(k1·ΔD1+k2·Vfx(a)) (2)

When an object does not exist in the following target vehicle area, the driving support ECU 10 determines the target acceleration Gtgt based on a “target speed set in accordance with the target inter-vehicle distance Ttgt” and the vehicle speed SPD of the own vehicle so that the vehicle speed SPD matches the target speed.

The driving support ECU 10 uses the engine ECU 20 to control the engine actuator 21, and, as required, uses the brake ECU 30 to control the brake actuator 31 so that the acceleration of the vehicle matches the target acceleration Gtgt.

<Lane Trace Control (LTC)>

The driving support ECU 10 executes the lane trace control when the lane trace control is requested by an operation on the operation switch 17 during the execution of the adaptive cruise control.

In the lane trace control, the driving support ECU 10 determines (sets) a target travel line (target travel path) by using any one of or both of the white lines and a travel trajectory (namely, preceding-vehicle trajectory) of the preceding vehicle. The driving support ECU 10 applies the steering torque to the steering mechanism so as to change the steered angles of the steered wheels of the own vehicle so that a lateral position (namely, a position of the own vehicle in the vehicle widthwise direction with respect to the road) of the own vehicle is maintained in a vicinity of the target travel line in a “lane (travel lane) in which the own vehicle is traveling” (see, for example, Japanese Patent Application Laid-open No. 2008-195402, Japanese Patent Application Laid-open No. 2009-190464, Japanese Patent Application Laid-open No. 2010-6279, and Japanese Patent No. 4349210). As a result, the steering operation by the driver is supported. Such lane trace control is also sometimes referred to as “traffic jam assist (TJA)”. The steering torque is different from an assist torque applied so as to assist the steering operation by the driver, and indicates a torque to be applied to the rack bar 64 through the drive of the motor 61 even without the steering operation by the driver.

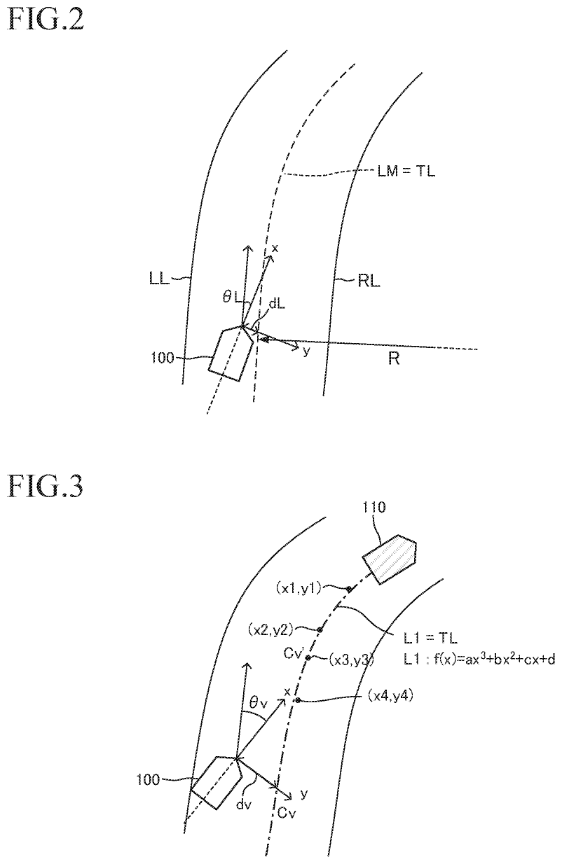

A description is now given of the lane trace control using the target travel line determined based on the white lines. As illustrated in FIG. 2, the driving support ECU 10 acquires information on a “left white line LL and right white line RL” of a travel lane in which the own vehicle 100 is traveling, based on lane information contained in the vehicle peripheral information. The driving support ECU 10 estimates, as a “center line LM of the travel lane”, a line connecting center positions between the acquired left white line LL and right white line RL in a road widthwise direction to one another.

Further, the driving support ECU 10 calculates a curve radius R and a curvature CL (=1/R) of the center line LM of the travel lane, and also calculates a position and a direction of the own vehicle 100 in the travel lane defined/partitioned by the left white line LL and the right white line RL. More specifically, as illustrated in FIG. 2, the driving support ECU 10 calculates a distance dL in a y-axis direction (substantially the road widthwise direction) between the center position of the own vehicle 100 in the vehicle widthwise direction and the center line LM of the travel lane, and calculates a deviation angle θL (yaw angle θL) between a direction (a tangent direction) of the center line LM and the travel direction of the own vehicle 100. Those parameters are target travel path information (the curvature CL of a target travel line TL, the yaw angle θL with respect to the target travel line TL, and the distance dL to the target travel line TL in the road widthwise direction) required for the lane trace control when the center line LM of the travel lane is set as the target travel line TL. x-y coordinates illustrated in FIG. 2 are coordinates obtained when the center axis extending in the front-rear direction of the own vehicle 100 is set as an x axis, the axis orthogonal to the x axis is set as a y axis, and a current position of the own vehicle 100 is set as an origin (x=0 and y=0).

The driving support ECU 10 calculates a target yaw rate YRc* by assigning the curvature CL, the vehicle speed SPD, the yaw angle θL, and the distance dL to Expression (3) each time a predetermined period elapses when executing the lane trace control. Further, the driving support ECU 10 obtains a target steering torque Tr* for achieving the target yaw rate YRc* by applying the target yaw rate YRc*, the actual yaw rate YRt, and the vehicle speed SPD to a lookup table Map1 (Yrc*, YRt, SPD) (that is, Tr*=Map1 (Yrc*, YRt, SPD)). Then, the driving support ECU 10 uses the steering ECU 40 to control the motor 61 so that the actual torque generated by the motor 61 matches the target steering torque Tr*. In Expression (3), K1, K2, and K3 represent control gains. The lookup table Map1 (YRc*, YRt, SPD) is stored in the ROM 10c.

YRc*=K1×dL+K2×θL+K3×CL×SPD (3)

This concludes the description of the overview of the lane trace control using the target travel line determined based on the white lines.

A description is now given of the lane trace control using the target travel line determined based on the preceding-vehicle trajectory. Such lane trace control is also referred to as “following steering control”. The preceding vehicle for which the preceding-vehicle trajectory is used to determine the target travel line is also referred to as “steering-following preceding vehicle”. The driving support ECU 10 identifies the preceding vehicle (namely, the steering-following preceding vehicle), which is an object for which the preceding-vehicle trajectory for determining the target travel line is to be generated, as in the case of the ACC following target vehicle.

As illustrated in FIG. 3, the driving support ECU 10 identifies a preceding vehicle 110, which is an object for which a preceding-vehicle trajectory L1 is to be generated, and generates the preceding-vehicle trajectory L1 based on object information containing position information on the preceding vehicle 110 with respect to the position of the own vehicle 100 for each predetermined period. For example, the driving support ECU 10 converts the position information on the preceding vehicle 110 to position coordinate data represented in the above-mentioned x-y coordinate system. For example, (x1, y1), (x2, y2), (x3, y3), and (x4, y4) of FIG. 3 are examples of the position coordinate data on the preceding vehicle 110 converted in such a manner. The driving support ECU 10 generates the preceding-vehicle trajectory L1 of the preceding vehicle 110 through application of curve fitting processing to the position coordinate data. A curve to be used for the fitting processing is a cubic function f(x). The fitting processing is executed through use of, for example, the least squares method.

The driving support ECU 10 calculates target travel path information (dv, θv, Cv, and Cv′ described below) required for the lane trace control when the preceding-vehicle trajectory L1 is set as the target travel line TL, based on the preceding-vehicle trajectory L1 of the preceding vehicle 110, and the position and the direction of the own vehicle 100.

dv: A distance in the y-axis direction (substantially the road widthwise direction) between the center position of the own vehicle 100 at the current position (x=0 and y=0) in the vehicle widthwise direction and the preceding-vehicle trajectory L1.

θv: A deviation angle (yaw angle) between the direction (tangent direction) of the preceding-vehicle trajectory L1 corresponding to the current position (x=0 and y=0) of the own vehicle 100 and the travel direction (the + direction of the x axis) of the own vehicle 100.

Cv: A curvature of the preceding-vehicle trajectory L1 at a position (x=0 and y=dv) corresponding to the current position (x=0 and y=0) of the own vehicle 100.

Cv′: A curvature change rate (a curvature change amount per unit distance (Δx) at any position (x=x0; x0 is any value) of the preceding-vehicle trajectory L1).

Then, the driving support ECU 10 calculates the target yaw rate YRc* by replacing dL by dv, replacing θL by θv, and replacing CL by Cv in Expression (3). Further, the driving support ECU 10 uses the lookup table Map1 (YRc*, YRt, SPD) to calculate the target steering torque Tr* for achieving the target yaw rate YRc*. Then, the driving support ECU 10 uses the steering ECU 40 to control the motor 61 so that the actual torque generated by the motor 61 matches the target steering torque Tr*.

This concludes the description of the overview of the lane trace control using the target travel line determined based on the preceding-vehicle trajectory.

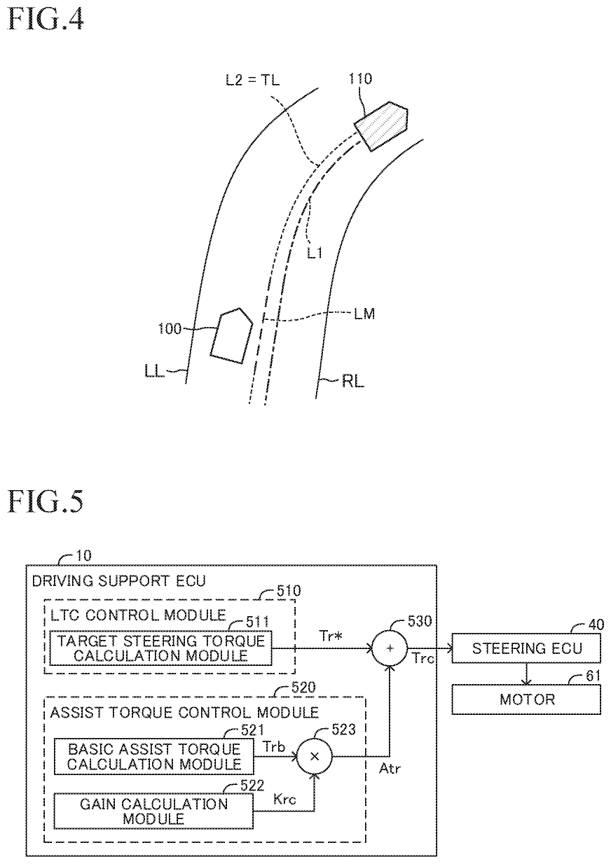

The driving support ECU 10 may be configured to generate the target travel line TL through use of a combination of the preceding-vehicle trajectory L1 and the center line LM of the travel lane. More specifically, for example, as illustrated in FIG. 4, the driving support ECU 10 corrects the preceding-vehicle trajectory L1 so that the preceding-vehicle trajectory L1 becomes a “trajectory maintaining the shape (curvature) of the preceding-vehicle trajectory L1 and matching the position of the center line LM and the direction (tangent direction) of the center line LM in a vicinity of the own vehicle 100”. As a result, a “preceding-vehicle trajectory (sometimes referred to as “corrected preceding-vehicle trajectory”) L2”, which is a trajectory maintaining a shape of the preceding-vehicle trajectory L1 and having a small error in the road widthwise direction, can be obtained as a target travel line TL. Then, the driving support ECU 10 acquires target travel path information at the time when the corrected preceding-vehicle trajectory L2 is set as the target travel line TL, and calculates the target steering torque Tr* based on the target travel path information and Expression (3). The driving support ECU 10 uses the steering ECU 40 to control the motor 61 so that the actual steering torque generated by the motor 61 matches the target steering torque Tr*.

For example, in such a manner as described in the items (a) to (d) given below, the driving support ECU 10 sets the target travel line TL in accordance with the presence/absence of the preceding vehicle and the recognition state of the white lines, to thereby execute the lane trace control.

(a) When the left and right white lines have been recognized up to a far position, the driving support ECU 10 sets the target travel line TL based on the center line LM of the travel lane, to thereby execute the lane trace control.

(b) When the steering-following preceding vehicle exists ahead of the own vehicle, and any one of the left and right white lines has not been recognized, the driving support ECU 10 sets the target travel line TL based on the preceding-vehicle trajectory L1 of the steering-following preceding vehicle, to thereby execute the lane trace control (following steering control).

(c) When the steering-following preceding vehicle exists ahead of the own vehicle, and the left and right white lines have been recognized in a vicinity of the own vehicle, the driving support ECU 10 sets, as the target travel line TL, the corrected preceding-vehicle trajectory L2 obtained by correcting the preceding-vehicle trajectory L1 of the steering-following preceding vehicle through use of the white lines, to thereby execute the lane trace control.

(d) When the steering-following preceding vehicle does not exist ahead of the own vehicle, and the white lines of the road have not been recognized up to a far position, the driving support ECU 10 cancels the lane trace control.

<Reaction Force Control during Lane Trace Control>

The first apparatus determines whether or not the driver operates the steering wheel SW and consequently the own vehicle 100 is approaching a “white line present on a side deviating from the lane” during the execution of the lane trace control. Hereinafter, the “white line present on the side deviating from the lane” is to as “white line on the lane-deviation side”. The “state in which the own vehicle 100 is approaching the white line on the lane-deviation side” is a state in which the own vehicle 100 is deviating from the target travel line TL and is approaching any one of the left and right white lines. When the first apparatus determines that the own vehicle 100 is approaching the “white line on the lane-deviation side”, the first apparatus applies an appropriate reaction force to the operation on the steering wheel SW. The driver can recognize, through the applied reaction force, that the own vehicle 100 may deviate from the lane (travel lane).

More specifically, as illustrated in FIG. 5, the driving support ECU 10 includes, from a functional viewpoint, an LTC control module (first calculation module) 510, an assist torque control module (second calculation module) 520, and an adder 530. The LTC control module 510 includes a target steering torque calculation module 511. The assist torque control module 520 includes a basic assist torque calculation module 521, a gain calculation module 522, and a multiplier 523.

The target steering torque calculation module 511 calculates the target yaw rate Yrc* through application of the curvature CL, the vehicle speed SPD, the yaw angle θL, and the distance dL to Expression (3) as described above. Further, the target steering torque calculation module 511 calculates the target steering torque Tr* through application of the target yaw rate YRc*, the actual yaw rate YRt, and the vehicle speed SPD to the lookup table Map1 (YRc*, YRt, SPD). The target steering torque calculation module 511 outputs the target steering torque Tr* to the adder 530. The target steering torque Tr* is a steering control amount for causing the own vehicle to travel along the target travel line TL as described above, and is sometimes referred to as “first steering control amount”.

The basic assist torque calculation module 521 applies the steering torque Tra and the vehicle speed SPD to a lookup table Map2 (Tra, SPD), to thereby calculate a basic assist torque Trb (that is, Trb=Map2 (Tra, SPD)) corresponding to the operation on the steering wheel SW by the driver. The basic assist torque Trb is sometimes referred to as “basic assist control amount”. For example, a magnitude (absolute value) of the basic assist torque Trb increases as a magnitude (absolute value) of the steering torque Tra increases in accordance with the lookup table Map2. Further, the magnitude (absolute value) of the basic assist torque Trb increases as the vehicle speed SPD decreases. The basic assist torque calculation module 521 outputs the basic assist torque Trb to the multiplier 523.

The gain calculation module 522 determines and sets a control gain Krc based on the vehicle peripheral information, the steering angle θ, and the like. In the first embodiment, the control gain Krc is set to a value of any one of “0” and “1”. The gain calculation module 522 outputs the control gain Krc to the multiplier 523.

The multiplier 523 obtains a value (=Krc×Trb) calculated by multiplying the basic assist torque Trb output from the basic assist torque calculation module 521 and the control gain Krc output from the gain calculation module 522 by each other, and outputs this value to the adder 530 as an assist torque Atr. The assist torque Atr is a steering control amount for assisting the operation on the steering wheel SW by the driver, and is sometimes referred to as “second steering control amount”.

The adder 530 obtains a torque control amount Trc (=Tr*+Atr), which is a value calculated by adding the target steering torque Tr* output from the LTC control module 510 and the assist torque Atr output from the assist torque control module 520 to each other, and outputs this torque control amount Trc to the steering ECU 40 as a final torque control amount. The steering ECU 40 controls the current caused to flow through the motor 61 so that the actual torque generated by the motor 61 matches the torque control amount Trc. As a result, the rotational torque of the motor 61 acts on the rack bar 64 through the torque conversion mechanism 62.

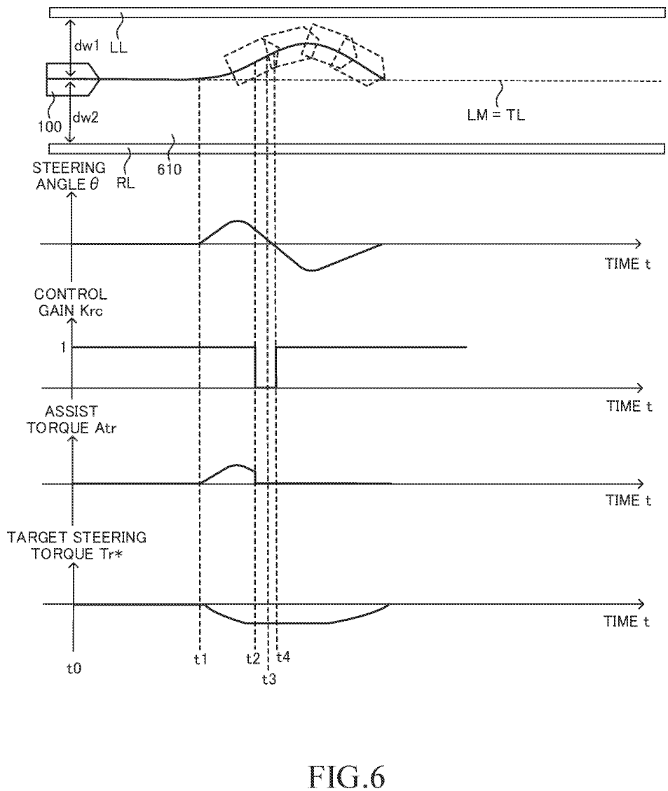

Referring to FIG. 6, a description is now given of an operation of the driving support ECU 10 to be performed when the driver operates the steering wheel SW toward the first direction (left direction) during the execution of the lane trace control. The vehicle 100 is traveling in a travel lane 610. The driving support ECU 10 sets a center line LM of the travel lane 610 as the target travel line TL, to thereby execute the lane trace control before a time point t0. A value of the control gain Krc is “1” at the time point t0.

The driving support ECU 10 calculates a first distance dw1 between the center position of the own vehicle 100 in the vehicle widthwise direction and the left white line LL, and a second distance dw2 between the center position of the own vehicle 100 in the vehicle widthwise direction and the right white line RL based on the lane information contained in the vehicle peripheral information each time a predetermined period elapses. Further, the driving support ECU 10 determines whether or not a predetermined first condition is satisfied. The first condition is satisfied when any one of the first distance dw1 and the second distance dw2 becomes equal to or shorter than a first distance threshold value Dth1.

In this example, at a time point t1, the driver starts operating the steering wheel SW toward the first direction (left direction). The driving support ECU 10 outputs the basic assist torque Trb, which has a positive value, so as to assist (support) an operation (steering operation) on the steering wheel SW toward the first direction in response to the operation. Further, the value of the control gain Krc is “1” at this time point. Thus, the assist torque Atr has a positive value (=1*Trb).

After the time point t1, the own vehicle 100 deflects toward the left side with respect to the target travel line TL as a result of the operation on the steering wheel SW by the driver. Thus, the driving support ECU 10 outputs the target steering torque Tr*, which has a negative value, so as to return the position of the own vehicle 100 to a position of the target travel line TL. At this time point, the assist torque Atr has a positive value, and the target steering torque Tr* has a negative value. Thus, the final torque control amount Trc, which is a sum of the assist torque Atr and the target steering torque Tr*, has a value close to zero. The driver feels that the own operation on the steering wheel SW is not sufficiently assisted, but does not feel a large reaction force against the operation on the steering wheel SW.

In this example, the first distance dw1 becomes equal to or shorter than the first distance threshold value Dth1 at a time point t2. Thus, the driving support ECU 10 determines that the first condition is satisfied.

When the first condition is satisfied, the driving support ECU 10 determines whether or not a predetermined second condition is satisfied. The second condition is satisfied when the own vehicle 100 is steered so as to approach the white line (“left white line LL” in this example).

Specifically, the driving support ECU 10 applies a curvature of the travel lane 610 (for example, the curvature CL of the target travel line TL) and the vehicle speed SPD to a lookup table Map3 (CL, SPD), to thereby calculate a reference steering angle θre required for the own vehicle 100 to travel along the target travel line TL. For example, a magnitude (absolute value) of the reference steering angle θre increases as a magnitude (absolute value) of the curvature CL increases in accordance with the lookup table Map3. Further, the magnitude (absolute value) of the reference steering angle θre decreases as the vehicle speed SPD decreases.

The driving support ECU 10 compares the reference steering angle θre and the actual steering angle θ with each other, to thereby determine whether or not the own vehicle 100 is steered so as to approach the left white line LL. The driving support ECU 10 determines whether or not the steering angle θ is an angle toward a lane-deviation direction while the reference steering angle θre is considered as a reference. In this case, the lane-deviation direction is a direction toward a white line (in this example, the left white line LL) that the own vehicle 100 is currently approaching. When the driving support ECU 10 determines that the steering angle θ is an angle toward the lane-deviation direction with respect to the reference steering angle θre, the driving support ECU 10 determines that the own vehicle 100 is steered so as to approach the left white line LL (that is, determines that the second condition is satisfied).

In this example, the own vehicle 100 is traveling in the straight travel lane 610, and it is thus assumed that the reference steering angle θre is “0”. Thus, the driving support ECU 10 determines that the steering angle θ is an angle toward the lane-deviation direction when the steering angle θ has a positive value under the state in which the first distance dw1 is equal to or shorter than the first distance threshold value Dth1.

The driving support ECU 10 determines that the first condition is satisfied also when the second distance dw2 is equal to or shorter than the first distance threshold value Dth1. In this case, the driving support ECU 10 determines whether or not the second condition is satisfied in the same manner as described above. Specifically, the driving support ECU 10 determines whether or not the own vehicle 100 is steered so as to approach the right white line RL. The driving support ECU 10 uses the lookup table Map3 (CL, SPD) to calculate the reference steering angle θre. Then, the driving support ECU 10 determines whether or not the steering angle θ is an angle toward the lane-deviation direction with respect to the reference steering angle θre. In this example, it is assumed that the reference steering angle θre is “0”. Thus, the driving support ECU 10 determines that the steering angle θ is an angle toward the lane-deviation direction when the steering angle θ has a negative value under the state in which the second distance dw2 is equal to or shorter than the predetermined first distance threshold value Dth1 (that is, determines that the second condition is satisfied).

The first condition and the second condition are sometimes collectively referred to as “white-line approach condition”. The white-line approach condition is only required to be a condition satisfied when the own vehicle 100 is estimated to have approached the white line through the operation on the steering wheel SW by the driver, and is not limited to the above-mentioned example.

When the white-line approach condition (the first condition and the second condition) is satisfied, the driving support ECU 10 determines whether or not the driver intends to deviate the own vehicle 100 from the travel lane 610. When a predetermined intention determination condition is satisfied, the driving support ECU 10 determines that the driver intends to deviate the own vehicle 100 from the travel lane 610. The intention determination condition is satisfied when one or both of the following condition A and condition B is satisfied.

(Condition A): The turn signal lamp 51 on the same side as the steering direction of the steering wheel SW is flashing.
(Condition B): A magnitude (absolute value |θ′|) of a steering angular velocity θ′ (namely, a change amount of the steering angle θ per unit time) is equal to or larger than a predetermined angular velocity threshold value θTh. When the magnitude (|θ′|) of the steering angular velocity θ′ is larger than the angular velocity threshold value θTh, the driver is highly likely to intentionally steer (for example, it is considered that the driver intends to avoid a fallen object on the travel lane 610).

In this example, it is assumed that any one of the condition A and the condition B is not satisfied. Thus, the intention determination condition is not satisfied. In this case, the driving support ECU 10 sets the value of the control gain Krc to “0”. In such a manner, the magnitude of the assist torque Atr immediately after the time point (time point t2) at which the white-line approach condition is satisfied is smaller than the magnitude of the assist torque Atr immediately before this time point (time point t2).

Specifically, the value of the assist torque Atr (=Krc*Trb) becomes zero immediately after the time point t2. Thus, the torque control amount Trc immediately after the time point (time point t2) at which the white-line approach condition is satisfied is a value obtained by subtracting the assist torque Atr from the torque control amount Trc immediately before that time point (time point t2). In other words, it can be considered that “the torque control amount Trc immediately before the time point (time point t2) at which the white-line approach condition is satisfied is changed by a torque component in such a direction that the own vehicle approaches the target travel line TL”. The processing of correcting the torque control amount Trc is sometimes referred to as “first correction control”.

Thus, only the torque component (target steering torque Tr*) in the direction opposite to the acting direction of the assist torque for assisting the steering operation by the driver remains in the final torque control amount Trc. A relatively large torque in the direction (second direction) opposite to the operation by the driver is generated on the steering wheel SW, and the driver thus feels a large reaction force. In this manner, the first apparatus can notify the driver that the own vehicle 100 is approaching the white line (left white line LL) through the reaction force. As a result, the driver can be prevented from further steering the steering wheel SW toward the first direction, and, as a result, the own vehicle 100 can be prevented from deviating from the travel lane 610.

The driver feels a large reaction force at a time point t3, and thus stops the operation on the steering wheel SW toward the first direction. That is, the driver is brought into a state in which the driver does not apply a force to the steering wheel SW. Thus, the own vehicle 100 is gradually returned to the target travel line TL by the lane trace control based on the target steering torque Tr*.

As a result, the value of the steering angle θ is inverted from a positive value to a negative value at a time point t4. The steering angle θ becomes an angle toward the direction for approaching the target travel line TL (that is, not an angle toward the lane-deviation direction) with respect to the reference steering angle θre (=0) at that time point. Thus, the driving support ECU 10 determines that the own vehicle 100 is not steered so as to approach the left white line LL. In this case, the driving support ECU 10 stops the first correction control. That is, the driving support ECU 10 sets the value of the control gain Krc to “1”.

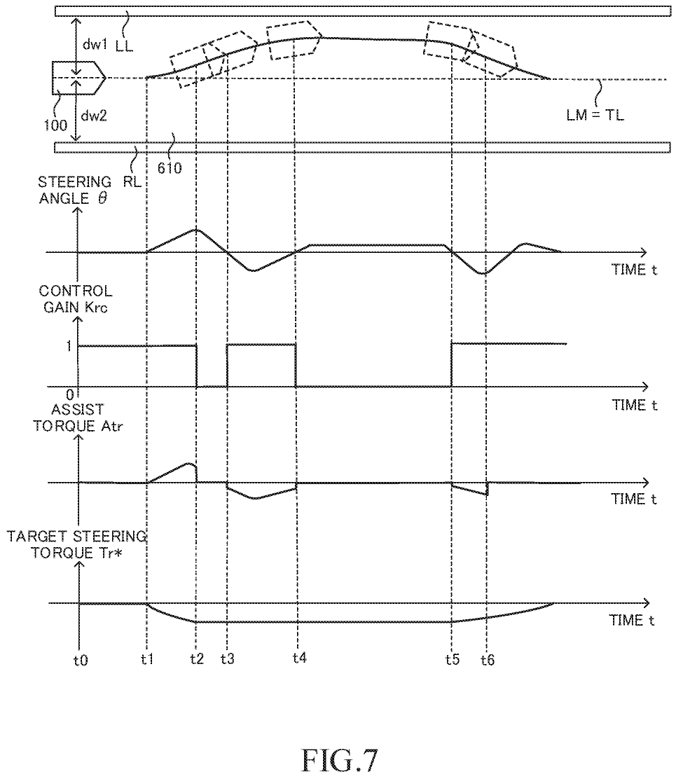

Referring to FIG. 7, a description is now given of an operation of the driving support ECU 10 for another example of the case in which the driver operates the steering wheel SW toward the first direction (left direction) during the execution of the lane trace control. In the example illustrated in FIG. 7, the operation of the driving support ECU 10 up to the time point t2 is the same as that in the example of FIG. 6. Thus, a description is given of the operation of the driving support ECU 10 on and after the time point t2.

The first distance dw1 becomes equal to or shorter than the predetermined first distance threshold value Dth1 at the time point t2, and the driving support ECU 10 thus determines that the first condition is satisfied. Then, the driving support ECU 10 determines whether or not the second condition is satisfied. Specifically, the driving support ECU 10 determines whether or not the own vehicle 100 is steered so as to approach the left white line LL. The driving support ECU 10 determines whether or not the steering angle θ is an angle toward the lane-deviation direction while the reference steering angle θre is considered as the reference. At this time point, the steering angle θ is an angle (namely, a positive value) toward the lane-deviation direction with respect to the reference steering angle θre (=0). Thus, the driving support ECU 10 determines that the own vehicle 100 is steered so as to approach the left white line LL (that is, determines that the second condition is satisfied).

Further, it is assumed that the intention determination condition is not satisfied at the time point t2. Thus, the driving support ECU 10 starts the first correction control. That is, the driving support ECU 10 sets the value of the control gain Krc to “0”. As a result, the assist torque Atr becomes “0” in the final torque control amount Trc immediately after the time point t2, and only the torque component (target steering torque Tr*) in the direction (second direction) opposite to the acting direction (first direction) of the assist torque Atr remains. A relatively large torque in the direction opposite to the operation by the driver is generated on the steering wheel SW, and the driver thus feels a large reaction force.

In this example, on and after the time point t2, the driver feels the large reaction force (load) against the operation on the steering wheel SW toward the first direction, and thus, starts operating the steering wheel SW toward the second direction. Then, at a time point t3, the value of the steering angle θ is inverted from a positive value to a negative value. That is, the steering angle θ is an angle toward the direction for approaching the target travel line TL with respect to the reference steering angle θre (=0). The steering is not performed so that the own vehicle 100 approaches the left white line LL, and the second condition is thus not satisfied. In this case, the driving support ECU 10 stops the first correction control. That is, the driving support ECU 10 sets the value of the control gain Krc to “1”.

At this time, the driving support ECU 10 outputs the basic assist torque Trb, which has a negative value, so as to assist an operation on the steering wheel SW toward the second direction in response to the operation. Thus, the assist torque Atr (=Krc·Trb) has a negative value. Further, the driving support ECU 10 outputs the target steering torque Tr*, which has a negative value, so as to return the position of the own vehicle 100 to the position of the target travel line TL. At this time point, the final torque control amount Trc, which is the sum of the assist torque Atr and the target steering torque Tr*, is a relatively large negative value. Thus, the operation on the steering wheel SW by the driver toward the second direction is assisted through use of the large torque. In this manner, the torque control amount Trc becomes a negative value having a large magnitude (absolute value) in a short period of time, and the own vehicle 100 can thus be prevented from deviating from the travel lane 610.

In this example, on and after the time point t3, the steering angle θ has a negative value, and the magnitude of the value gradually increases, and then gradually decreases through the operation on the steering wheel SW by the driver. Then, at a time point t4, the value of the steering angle θ becomes “0”. Further, the steering angle θ is maintained to be a positive constant value on and after the time point t4. As a result, on and after the time point t4, the own vehicle 100 travels at a position close to the left white line LL along the travel lane 610. At this time, the first distance dw1 is equal to or shorter than the first distance threshold value Dth1, and the first condition is thus satisfied.

In this state, the steering angle θ has a positive value, and is an angle toward the lane-deviation direction with respect to the reference steering angle (“0” in this case). The driving support ECU 10 thus determines that the second condition is satisfied. Thus, the driving support ECU 10 starts the first correction control again. That is, the driving support ECU 10 sets the value of the control gain Krc to “0”. As a result, the assist torque Atr (=Krc×Trb) becomes zero. Thus, only the torque component (target steering torque Tr*) in the direction opposite to the acting direction of the assist torque remains in the final torque control amount Trc. As a result, a relatively large torque in the direction (second direction) opposite to the operation by the driver is generated on the steering wheel SW, and the driver thus feels a large reaction force. As a result, the driver recognizes again that the own vehicle 100 is still traveling at a position close to the left white line LL. Consequently, the driver can be prevented from further operating the steering wheel SW toward the first direction.

At a time point t5, the driver starts operating the steering wheel SW toward the second direction (right direction) so as to return the position of the own vehicle 100 to the position of the target travel line TL. Thus, the value of the steering angle θ is inverted from a positive value to a negative value. That is, the steering angle θ is an angle toward a direction for approaching the target travel line TL with respect to the reference steering angle θre (=0). The steering is not performed so that the own vehicle 100 approaches the left white line LL, and the second condition is thus not satisfied. In this case, the driving support ECU 10 stops the first correction control. That is, the driving support ECU 10 sets the value of the control gain Krc to “1”. As a result, the assist torque Atr is added to the final torque control amount Trc.

The driving support ECU 10 outputs the basic assist torque Trb, which has a negative value, so as to assist an operation on the steering wheel SW toward the second direction in response to the operation. Thus, the assist torque Atr (=Krc·Trb) has a negative value. Further, the driving support ECU 10 outputs the target steering torque Tr*, which has a negative value, so as to return the position of the own vehicle 100 to the position of the target travel line TL. At this time point, the final torque control amount Trc, which is the sum of the assist torque Atr and the target steering torque Tr*, is a relatively large negative value. Thus, the operation on the steering wheel SW by the driver toward the second direction is assisted through use of the large torque. As a result, the driver can easily return the position of the own vehicle 100 to the position of the target travel line TL.

At a time point t6, the driver stops the operation of the steering wheel SW toward the second direction. That is, the driver is brought into a state in which the driver does not apply a force to the steering wheel SW. As a result, the basic assist torque Trb becomes zero. Thus, the assist torque Atr (=Krc×Trb) becomes zero. After that, the own vehicle 100 is gradually returned to the target travel line TL by the lane trace control based on the target steering torque Tr*.

<Operation>

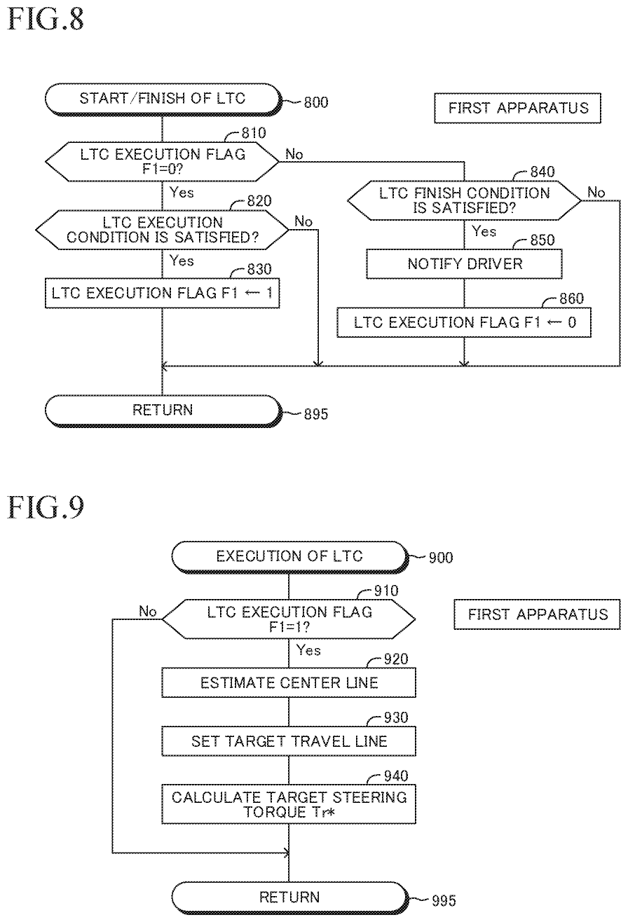

A description is now given of an operation of the CPU of the driving support ECU 10 (hereinafter sometimes simply referred to as “CPU”). The CPU is configured to execute the adaptive cruise control (ACC) through execution of a routine (not shown). The CPU is configured to execute an “LTC start/finish determination routine” illustrated in FIG. 8 when executing the adaptive cruise control.

Thus, the CPU starts the routine of FIG. 8 from Step 800 at a predetermined timing, and proceeds to Step 810 to determine whether or not a value of an LTC execution flag F1 is “0”. When the value of the LTC execution flag F1 is “1”, this indicates a state in which the lane trace control is being executed. When the value of the LTC execution flag F1 is “0”, this indicates a state in which the lane trace control is not being executed. The value of the LTC execution flag F1 is set to “0” in an initialization routine to be executed by the CPU when an ignition switch (not shown) is changed from an OFF position to an ON position. Further, the value of the LTC execution flag F1 is set to “0” also in Step 860 described later.

When it is assumed that the lane trace control is currently not being executed, the value of the LTC execution flag F1 is “0”. In this case, the CPU makes a determination of “Yes” in Step 810, and proceeds to Step 820 to determine whether or not a predetermined execution condition is satisfied. This execution condition is also referred to as “LTC execution condition”.

The LTC execution condition is satisfied when all the following conditions 1 and 2 are satisfied.

(Condition 1): The adaptive cruise control is being executed, and the execution of the lane trace control is selected through the operation on the operation switch 17.

(Condition 2): The left white line LL and the right white line RL can be recognized by the camera sensor 16b from the own vehicle up to a far position.

When the LTC execution condition is not satisfied, the CPU makes a determination of “No” in Step 820, and directly proceeds to Step 895 to temporarily finish this routine.

In contrast, when the LTC execution condition is satisfied, the CPU makes a determination of “Yes” in Step 820, and proceeds to Step 830 to set the LTC execution flag F1 to “1”. After that, the CPU proceeds to Step 895 to temporarily finish this routine. As a result, the lane trace control is started (see a determination of “Yes” in Step 910 of the routine of FIG. 9).

When the CPU starts the routine of FIG. 8 again from Step 800 after the lane trace control is started as described above, the CPU makes a determination of “No” in Step 810, and proceeds to Step 840. In Step 840, the CPU determines whether or not a predetermined finish condition is satisfied. This finish condition is also referred to as “LTC finish condition”.

The LTC finish condition is satisfied when any one of the following conditions 3 and 4 are satisfied.

(Condition 3): The finish of the execution of the lane trace control is selected by the operation on the operation switch 17.

(Condition 4): Any one of the left white line and the right white line cannot be recognized by the camera sensor 16b. That is, the information required for the lane trace control cannot be acquired.

When the LTC finish condition is not satisfied, the CPU makes a determination of “No” in Step 840, and directly proceeds to Step 895 to temporarily finish this routine.

In contrast, when the LTC finish condition is satisfied, the CPU makes a determination of “Yes” in Step 840, and sequentially executes the processing of Step 850 and Step 860 described below. After that, the CPU proceeds to Step 895 to temporarily finish this routine.

Step 850: The CPU displays on the display 52 a notification that the lane trace control is to be finished. As a result, the CPU notifies the driver of the finish of the lane trace control.

Step 860: The CPU sets the value of the LTC execution flag F1 to “0”.

Further, the CPU is configured to execute an “LTC execution routine” illustrated in FIG. 9 as a flowchart each time a predetermined period elapses. Thus, the CPU starts processing from Step 900 of FIG. 9 at a predetermined timing, and proceeds to Step 910 to determine whether or not the value of the LTC execution flag F1 is “1”.

When the value of the LTC execution flag F1 is not “1”, the CPU makes a determination of “No” in Step 910, and directly proceeds to Step 995 to temporarily finish this routine.

In contrast, when the value of the LTC execution flag F1 is “1”, the CPU makes a determination of “Yes” in Step 910, and sequentially executes processing of from Step 920 to Step 940 described below. After that, the CPU proceeds to Step 995 to temporarily finish this routine.

Step 920: The CPU estimates a line connecting the center positions between the left white line LL and the right white line RL to each another based on the lane information contained in the vehicle peripheral information, and determines the estimated line as the “center line LM”.

Step 930: The CPU sets the center line LM as the target travel line TL.

Step 940: The CPU calculates the target steering torque Tr* as the first steering control amount as described above.

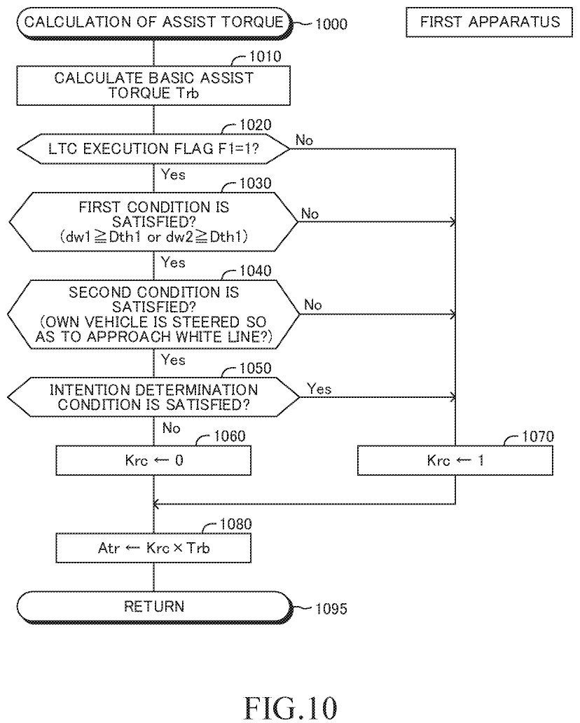

Further, the CPU is configured to execute an “assist torque calculation routine” illustrated in FIG. 10 as a flowchart each time a predetermined period elapses. Thus, the CPU starts the processing from Step 1000 of FIG. 10 at a predetermined timing, and proceeds to Step 1010 to apply the steering torque Tra and the vehicle speed SPD to the lookup table Map2 (Tra, SPD), to thereby calculate the basic assist torque Trb.

Then, in Step 1020, the CPU determines whether or not the value of the LTC execution flag F1 is “1”.

When the value of the LTC execution flag F1 is not “1” (that is, the lane trace control is not being executed), the CPU makes a determination of “No” in Step 1020, and proceeds to Step 1070 to set the value of the control gain Krc to “1”. Then, the CPU proceeds to Step 1080 to calculate the assist torque Atr (=Krc×Trb) as the second steering control amount. After that, the CPU proceeds to Step 1095 to temporarily finish this routine.

In contrast, when the value of the LTC execution flag F1 is “1” (that is, the lane trace control is being executed), the CPU makes a determination of “Yes” in Step 1020, and proceeds to Step 1030 to determine whether or not the predetermined first condition is satisfied. The first condition is satisfied when any one of the following conditions 5 and 6 is satisfied. The first distance threshold value Dth1 is set to a value (for example, W/4) shorter than a width W of the travel lane 610 (a distance between the left white line LL and the right white line RL).

(Condition 5): The first distance dw1 is equal to or shorter than the first distance threshold value Dth1.

(Condition 6): The second distance dw2 is equal to or shorter than the first distance threshold value Dth1.

When it is assumed that the first condition is currently satisfied, the CPU makes a determination of “Yes” in Step 1030, and proceeds to Step 1040 to determine whether or not the predetermined second condition is satisfied. The second condition is satisfied when the own vehicle 100 is steered so that the own vehicle 100 approaches the white line as described above. Specifically, the CPU applies the curvature of the travel lane 610 (the curvature CL of the target travel line TL) and the vehicle speed SPD to the lookup table Map3 (CL, SPD), to thereby calculate the reference steering angle θre required for the own vehicle 100 to travel along the target travel line TL. The CPU determines whether or not the steering angle θ is an angle toward the lane-deviation direction with respect to the reference steering angle θre. When the CPU determines that the steering angle θ is an angle toward the lane-deviation direction with respect to the reference steering angle θre, the CPU determines that the own vehicle 100 is steered so that the own vehicle 100 approaches the white line (that is, determines that the second condition is satisfied).

When it is assumed that the second condition is currently satisfied, the CPU makes a determination of “Yes” in Step 1040, and proceeds to Step 1050 to determine whether or not the intention determination condition is satisfied. Specifically, the CPU determines whether or not one or both of the above-mentioned conditions A and B is satisfied.

When it is assumed that the intention determination condition is not currently satisfied, the CPU makes a determination of “No” in Step 1050, and proceeds to Step 1060 to set the value of the control gain Krc to “0”. Then, the CPU proceeds to Step 1080 to calculate the assist torque Atr (=Krc×Trb) as the second steering control amount. In this case, the assist torque Atr becomes zero. After that, the CPU proceeds to Step 1095 to temporarily finish this routine.

Meanwhile, when the first condition is not satisfied at a time point at which the CPU proceeds to Step 1030, the CPU makes a determination of “No” in Step 1030, and proceeds to Step 1070. Further, when the second condition is not satisfied at a time point at which the CPU proceeds to Step 1040, the CPU makes a determination of “No” in Step 1040, and proceeds to Step 1070. Additionally, when the intention determination condition is satisfied at a time point at which the CPU proceeds to Step 1050, the CPU makes a determination of “Yes” in Step 1050, and proceeds to Step 1070. When the CPU proceeds to Step 1070, the CPU sets the value of the control gain Krc to “1”. Next, the CPU proceeds to Step 1080 to calculate the assist torque Atr (=Krc×Trb) as the second steering control amount. After that, the CPU proceeds to Step 1095 to temporarily finish this routine.

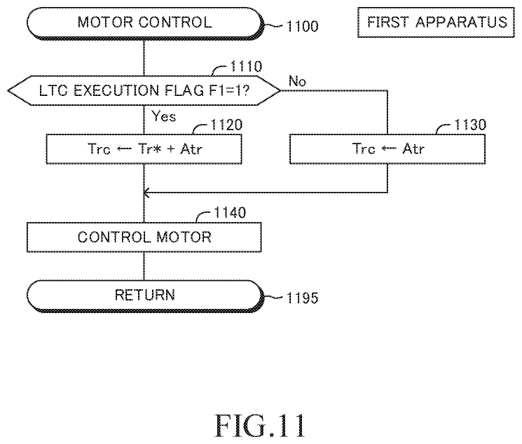

Further, the CPU is configured to execute a “motor control routine” illustrated in FIG. 11 as a flowchart each time a predetermined period elapses. Thus, the CPU starts processing from Step 1100 of FIG. 11 at a predetermined timing, and proceeds to Step 1110 to determine whether or not the value of the LTC execution flag F1 is “1”.

When the value of the LTC execution flag F1 is “1”, the CPU makes a determination of “Yes” in Step 1110, and proceeds to Step 1120 to obtain a value (=Tr*+Atr) by adding the target steering torque Tr* and the assist torque Atr to each other and set this value as the final torque control amount Trc. Then, in Step 1140, the CPU controls the motor 61 based on the torque control amount Trc. The CPU uses the steering ECU 40 to control the motor 61 so that the actual torque generated by the motor 61 matches the torque control amount Trc. After that, the CPU proceeds to Step 1195 to temporarily finish this routine.

In contrast, when the value of the LTC execution flag F1 is not “1”, the CPU makes a determination of “No” in Step 1110, and proceeds to Step 1130 to set the assist torque Atr as the final torque control amount Trc. Then, in Step 1140, the CPU controls the motor 61 based on the torque control amount Trc. The CPU uses the steering ECU 40 to control the motor 61 so that the actual torque generated by the motor 61 matches the torque control amount Trc. After that, the CPU proceeds to Step 1195 to temporarily finish this routine.

As described above, when the first apparatus determines that the white-line approach condition is satisfied (that is, both the first condition and the second condition are satisfied) during the execution of the lane trace control, the first apparatus executes the first correction control of decreasing the assist torque Atr to zero. Thus, the torque control amount Trc immediately after the time point (time point t2) at which the white-line approach condition is satisfied is a value obtained by subtracting the assist torque Atr from the torque control amount Trc immediately before the time point (time point t2) at which the white-line approach condition is satisfied. That is, only the torque component (target steering torque Tr*) in the direction opposite to the acting direction of the assist torque remains in the final torque control amount Trc. Thus, a relatively large torque in the direction opposite to the operation by the driver is generated on the steering wheel SW, and the driver thus feels a large reaction force. The first apparatus can notify the driver of a state in which the own vehicle 100 has approached the white line (that is, the own vehicle 100 may depart from the travel lane 610) through this reaction force.

Further, when the first apparatus determines that the own vehicle 100 is not steered so as to approach the white line (that is, the second condition is not satisfied) after the start of the first correction control, the first apparatus stops the first correction control. When the first correction control is stopped, the assist torque Atr is added to the torque control amount Trc, and thus the operation on the steering wheel SW by the driver is assisted. As a result, the driver can easily return the position of the own vehicle 100 to the position of the target travel line TL.

### Second Embodiment

A description is now given of a driving support apparatus (hereinafter sometimes referred to as “second apparatus”) according to a second embodiment. The second apparatus is different from the first apparatus in that the value of the control gain Krc is set to a “value larger than 1” when the driver operates the steering wheel SW toward the direction of departing from the white line under the state in which the own vehicle has approached the white line. A description is now mainly given of this difference.

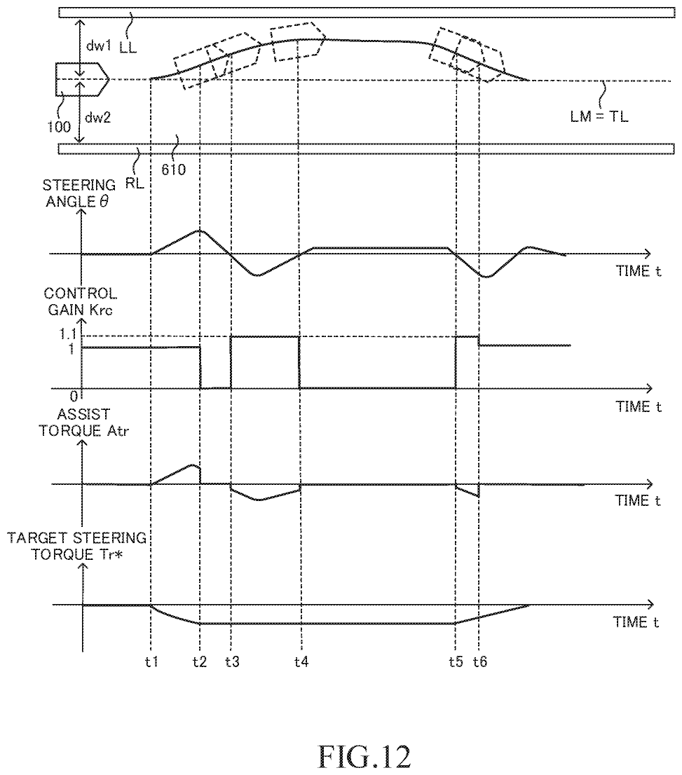

Referring to FIG. 12, a description is now given of an operation of the driving support ECU 10 to be performed when the driver operates the steering wheel SW toward the first direction (left direction) during the execution of the lane trace control. In the example illustrated in FIG. 12, the operation of the driving support ECU 10 up to the time point t2 is the same as that in the example of FIG. 7. Thus, a detailed description is given of the operation of the driving support ECU 10 on and after the time point t2.

The driving support ECU 10 determines that the white-line approach condition (the first condition and the second condition) is satisfied at the time point t2. Further, it is assumed that the intention determination condition is not satisfied. Thus, the driving support ECU 10 starts the first correction control.

On and after the time point t2, the driver feels the large reaction force (load) against the operation on the steering wheel SW toward the first direction, and thus starts operating the steering wheel SW toward the second direction. At a time point t3, the value of the steering angle θ is inverted from a positive value to a negative value. That is, the steering angle θ is an angle toward a direction for approaching the target travel line TL with respect to the reference steering angle θre (=0). Thus, the driving support ECU 10 determines that the second condition is not satisfied (the own vehicle 100 is not steered so as to approach the left white line LL). In this case, the driving support ECU 10 determines whether or not the driver is operating the steering wheel SW based on the steering torque Tra.

For example, the driving support ECU 10 determines that the driver is steering the steering wheel SW when the value of the steering torque Tra has the same direction as that of the target steering torque Tr*, and the magnitude (absolute value) of the steering torque Tra is larger than a reference steering torque Tre. In this example, the reference steering torque Tre is set to a predetermined value larger than “0”. The reference steering torque Tre may be changed in accordance with a travel state (for example, a state in which the own vehicle 100 is traveling on a curve) of the own vehicle 100.

Thus, in a case in which the first distance dw1 is equal to or shorter than the first distance threshold value Dth1, when the steering torque Tra has a negative value, and the magnitude (absolute value) of the steering torque Tra is larger than the reference steering torque Tre, the driving support ECU 10 determines that the driver is operating the steering wheel SW.

In a case in which the second distance dw2 is equal to or shorter than the first distance threshold value Dth1, when the steering torque Tra has a positive value, and the magnitude (absolute value) of the steering torque Tra is larger than the reference steering torque Tre, the driving support ECU 10 determines that the driver is operating the steering wheel SW.

In this example, the value of the steering torque Tra has a negative value at the time point t3, and the driving ECU 10 thus determines that the driver is operating the steering wheel SW. In this case, the driving support ECU 10 stops the first correction control. Then, the driving support ECU 10 sets the value of the control gain Krc to a “value larger than 1 (for example, ‘1.1’)”. As a result, at a certain time point on and after the time point (time point t3) at which the driver is determined to be operating the steering wheel SW, the magnitude (absolute value) of the assist torque Atr becomes larger than the magnitude (absolute value) of the basic assist torque Trb corresponding to the operation on the steering wheel SW at this time point. The processing of correcting the basic assist torque Trb is sometimes referred to as “second correction control”.

At the time point t3, the driving support ECU 10 outputs the basic assist torque Trb, which has a negative value, so as to assist an operation on the steering wheel SW toward the second direction in response to the operation. The value of the control gain Krc is “1.1”, and the magnitude of the assist torque Atr (=Krc×Trb) is thus larger than the magnitude of the basic assist torque Trb at that time point. Thus, the operation on the steering wheel SW by the driver toward the second direction is assisted through use of a larger torque compared with that in the example of FIG. 7. As a result, the driver can return the position of the own vehicle 100 to the target travel line TL through use of a smaller steering amount.

On and after the time point t3, the own vehicle 100 travels at a position close to the left white line LL along the travel lane 610 through the operation on the steering wheel SW by the driver. At this time, the first distance dw1 is equal to or shorter than the first distance threshold value Dth1, and the first condition is thus satisfied.

At a time point t4, the value of the steering angle θ is inverted from a negative value to a positive value under the state in which the first condition is satisfied. The steering angle θ is the angle toward the lane-deviation direction with respect to the reference steering angle (“0” in this case), and the driving support ECU 10 thus determines that the second condition is satisfied. In this case, the driving support ECU 10 sets the value of the control gain Krc to “0”. That is, the driving support ECU 10 stops the second correction control, and resumes the first correction control. As a result, the assist torque Atr (=Krc×Trb) becomes zero. Thus, only the torque component (target steering torque Tr*) in the direction opposite to the acting direction of the assist torque remains in the final torque control amount Trc. A relatively large torque in the direction (second direction) opposite to the operation by the driver is generated on the steering wheel SW, and the driver thus feels a large reaction force. As a result, the driver recognizes again that the own vehicle 100 is still traveling at a position close to the left white line LL. Consequently, the driver can be prevented from further operating the steering wheel SW toward the first direction.

At a time point t5, the driver starts operating the steering wheel SW toward the second direction (right direction) so as to return the position of the own vehicle 100 to the position of the target travel line TL. Thus, the value of the steering angle θ is inverted from a positive value to a negative value. Therefore, the driving support ECU 10 determines that the second condition is not satisfied (the own vehicle 100 is not steered so as to approach the left white line LL). Further, as described above, the driving support ECU 10 determines that the driver is operating the steering wheel SW based on the value of the steering torque Tra. As a result, the driving support ECU 10 sets the value of the control gain Krc to “1.1”. That is, the driving support ECU 10 stops the first correction control, and starts the second correction control. At this time, the driving support ECU 10 outputs the basic assist torque Trb, which has a negative value, so as to assist an operation on the steering wheel SW toward the second direction in response to the operation. The value of the control gain Krc is “1.1”, and the magnitude of the assist torque Atr (=Krc×Trb) is thus larger than the magnitude of the basic assist torque Trb at that time point. Thus, the operation on the steering wheel SW by the driver toward the second direction is assisted through use of a larger torque compared with that in the example of FIG. 7. As a result, the driver can more easily return the position of the own vehicle 100 to the position of the target travel line TL than in the first apparatus.

At a time point t6, the driver stops the operation of the steering wheel SW toward the second direction. That is, the driver is brought into a state in which the driver does not apply a force to the steering wheel SW. The value of the steering torque Tra becomes zero, and the driving support ECU 10 thus determines that driver is not operating the steering wheel SW, based on the value of the steering torque Tra. In this case, the driving support ECU 10 sets the value of the control gain Krc to “1”. That is, the driving support ECU 10 stops the second correction control.

After that, the own vehicle 100 is gradually returned to the target travel line TL by the lane trace control based on the target steering torque Tr*.

<Operation>

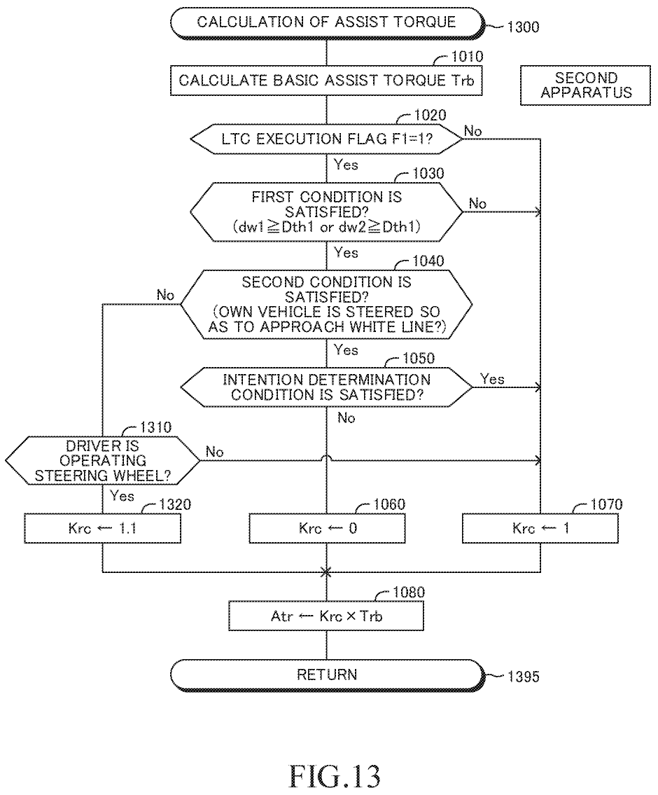

The second apparatus is different from the first apparatus in that the CPU of the driving support ECU 10 of the second apparatus (simply referred to as “CPU”) executes an “assist torque calculation routine illustrated as a flowchart in FIG. 13” in place of the routine of FIG. 10. A description is now mainly given of this difference.

The CPU is configured to execute the routine illustrated in FIG. 13 in place of the routine illustrated in FIG. 10 each time a predetermined period elapses. The routine illustrated in FIG. 13 is a routine obtained by adding Step 1310 and Step 1320 to the routine illustrated in FIG. 10. In FIG. 13, steps in which the same processing as that in the steps illustrated in FIG. 10 is executed are indicated by the same reference numerals of FIG. 10 indicating those steps. Therefore, a detailed description is omitted for the steps indicated by the same reference numerals as those of FIG. 10.

When the CPU proceeds to Step 1040, the CPU determines whether or not the second condition is satisfied. It is assumed that the second condition is not currently satisfied (the own vehicle 100 is not steered so as to approach the white line). In this case, the CPU makes a determination of “No” in Step 1040, and proceeds to Step 1310.

In Step 1310, the CPU determines whether or not the driver is operating the steering wheel SW as described above. Specifically, the CPU determines that the driver is steering the steering wheel SW when the value of the steering torque Tra has the same direction as that of the target steering torque Tr*, and the magnitude (absolute value) of the steering torque Tra is larger than the reference steering torque Tre (this condition is referred to as “driver steering condition”). Meanwhile, when the driver steering condition is not satisfied, the CPU determines that the driver is not steering the steering wheel SW.

When it is assumed that the driver is currently operating the steering wheel SW, the CPU makes a determination of “Yes” in Step 1310, and proceeds to Step 1320 to set the value of the control gain Krc to “1.1”. Then, the CPU proceeds to Step 1080 to calculate the assist torque Atr (=Krc×Trb) as the second steering control amount. After that, the CPU proceeds to Step 1395 to temporarily finish this routine.

In contrast, it is assumed that the driver is not operating the steering wheel SW at the time point at which the CPU proceeds to Step 1310. In this case, the CPU makes a determination of “No” in Step 1310, and proceeds to Step 1070 to set the value of the control gain Krc to “1”. Then, the CPU proceeds to Step 1080 to calculate the assist torque Atr (=Krc×Trb) as the second steering control amount. After that, the CPU proceeds to Step 1395 to temporarily finish this routine.

As described above, the second apparatus executes the second correction control of setting the value of the control gain Krc to “1.1” when the driver steers the steering wheel SW toward the direction for departing from the white line under the state in which the own vehicle 100 has approached the white line. As a result, the magnitude of the assist torque Atr is larger than the magnitude of the basic assist torque Trb corresponding to the operation on the steering wheel SW at that time point. Thus, when the driver operates the steering wheel SW so that the own vehicle 100 departs from the white line, this operation on the steering wheel SW is assisted by a larger torque compared with the case of the first apparatus. As a result, the driver can more easily return the position of the own vehicle 100 to the position of the target travel line TL than in the first apparatus.

### Third Embodiment

A description is now given of a driving support apparatus (hereinafter sometimes referred to as “third apparatus”) according to a third embodiment. The third apparatus is different from the first apparatus in that the third apparatus sets the value of the control gain Krc to “0” when the own vehicle 100 approaches a 3D object existing around the own vehicle 100. A description is now mainly given of this difference.

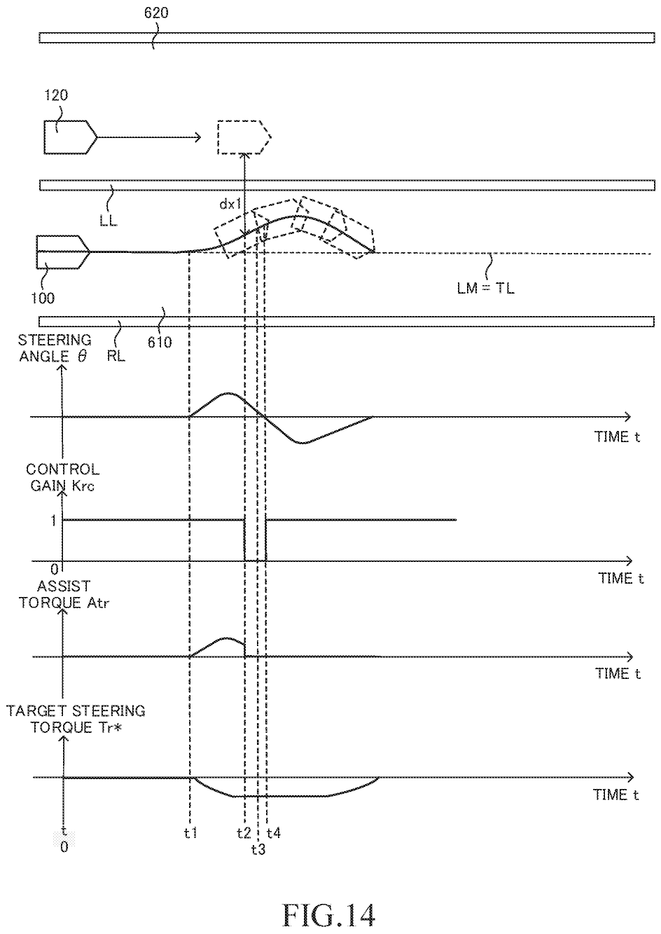

Referring to FIG. 14, a description is now given of an operation of the driving support ECU 10 of the third apparatus. Before a time point t0, the vehicle 100 sets the center line LM of the travel lane 610 as the target travel line TL, to thereby execute the lane trace control. Further, an adjacent lane 620 adjacent to the travel lane 610 exists, and another vehicle 120 is traveling at a position close to the travel lane 610 in the adjacent lane 620.

The driving support ECU 10 determines whether or not a 3D object (including a moving object and a fixed object) exists around the own vehicle 100 based on the object information contained in the vehicle peripheral information each time a predetermined period elapses. The driving support ECU 10 estimates an absolute speed of the 3D object based on a relative speed between the 3D object and the own vehicle 100, and on the speed of the own vehicle 100. The driving support ECU 10 then determines that the 3D object is a moving object when the absolute speed is higher than a predetermined threshold value, and determines that the 3D object is a fixed object when the absolute speed is lower than the threshold value. In the example of FIG. 14, the driving support ECU 10 recognizes the another vehicle 120 as a moving object based on the object information.

The driving support ECU 10 may extract a feature of a 3D object from the image data acquired by the camera sensor 16b, and determine whether the 3D object is a moving object or a fixed object based on the feature and a “relationship between features and types of a 3D object” stored in the ROM in advance.

When a moving object exists around the own vehicle 100, the driving support ECU 10 calculates a distance dx1 in the road widthwise direction between the own vehicle 100 and the moving object each time a predetermined period elapses. In this example, the driving support ECU 10 calculates the distance dx1 in the road widthwise direction between the own vehicle 100 and the another vehicle 120. Further, the driving support ECU 10 determines whether or not a predetermined third condition is satisfied. The third condition is a condition relating to a positional relationship between the own vehicle 100 and a 3D object existing in a periphery of the own vehicle 100. The third condition is satisfied, for example, when the distance dx1 becomes equal to or shorter than a predetermined distance threshold value Dth2.

In this example, at a time point t1, the driver starts operating the steering wheel SW toward the first direction (left direction). The driving support ECU 10 outputs the basic assist torque Trb, which has a positive value, so as to assist an operation on the steering wheel SW toward the first direction in response to the operation. Further, the value of the control gain Krc is “1” at this time point. Thus, the assist torque Atr has a positive value (=Krc*Trb).

After the time point t1, the own vehicle 100 deflects toward the left side with respect to the target travel line TL as a result of the operation on the steering wheel SW by the driver. Thus, the driving support ECU 10 outputs the target steering torque Tr*, which has a negative value, so as to return the position of the own vehicle 100 to a position of the target travel line TL. At this time point, the assist torque Atr has a positive value, and the target steering torque Tr* has a negative value. Thus, the final torque control amount Trc, which is a sum of the assist torque Atr and the target steering torque Tr*, has a value close to zero. The driver feels that the own operation on the steering wheel SW is not sufficiently assisted, but does not feel a large reaction force against the operation on the steering wheel SW.

At a time point t2, the distance dx1 becomes equal to or shorter than the second distance threshold value Dth2. Thus, the driving support ECU 10 determines that the third condition is satisfied. In this case, the driving support ECU 10 determines whether or not a predetermined fourth condition is satisfied. The fourth condition is satisfied when the own vehicle 100 is steered so as to approach a moving object (another vehicle 120).

Specifically, the driving support ECU 10 uses the lookup table Map3 (CL, SPD) to calculate the reference steering angle θre. Then, the driving support ECU 10 determines whether or not the steering angle θ is an angle toward an object approach direction with respect to the reference steering angle θre. In this case, the object approach direction is a direction toward a moving object (another vehicle 120) that the own vehicle 100 is currently approaching. When the driving support ECU 10 determines that the steering angle θ is an angle toward the object approach direction with respect to the reference steering angle θre, the driving support ECU 10 determines that the own vehicle 100 is steered so as to approach the moving object (another vehicle 120) (that is, determines that the fourth condition is satisfied).

In this example, the own vehicle 100 is traveling on the straight travel lane 610. Therefore, the reference steering angle θre is “0”. Further, the another vehicle 120 exists on the left side of the own vehicle 100. In this case, when the steering angle θ is an angle toward the object approach direction (that is, a positive value) with respect to the reference steering angle θre (=0), the driving support ECU 10 determines that the own vehicle 100 is steered so as to approach the moving object (another vehicle 120) (that is, determines that the fourth condition is satisfied).

When the another vehicle 120 exists on the right side of the own vehicle 100, and the steering angle θ is an angle toward the object approach direction (that is, a negative value) with respect to the reference steering angle θre (=0), the driving support ECU 10 determines that the own vehicle 100 is steered so as to approach the moving object (another vehicle 120) (that is, determines that the fourth condition is satisfied).

The third condition and the fourth condition are sometimes collectively referred to as “object approach condition”. The object approach condition is only required to be a condition satisfied when the own vehicle 100 is estimated to have approached a 3D object through the operation on the steering wheel SW by the driver, and is not limited to the above-mentioned example.

The fourth condition is satisfied at the time point t2. Thus, the driving support ECU 10 sets the value of the control gain Krc to “0”. That is, the driving support ECU 10 starts the first correction control. As a result, the assist torque Atr (=Krc×Trb) becomes zero. That is, in the final torque control amount Trc, the assist torque Atr is zero, and only the torque component (target steering torque Tr*) in the direction opposite to the acting direction of the assist torque Atr remains. A relatively large torque in the direction (second direction) opposite to the operation by the driver is generated on the steering wheel SW, and the driver thus feels a large reaction force. The third apparatus can use that reaction force to notify that the own vehicle 100 is approaching the 3D object (in this example, the another vehicle 120) existing around the own vehicle 100. Consequently, the driver can be prevented from further operating the steering wheel SW toward the first direction. As a result, the own vehicle 100 can be prevented from excessively approaching the another vehicle 120.

The driver feels a large reaction force at a time point t3, and thus stops the operation on the steering wheel SW toward the first direction. That is, the driver is brought into a state in which the driver does not apply a force to the steering wheel SW. Thus, the own vehicle 100 is gradually returned to the target travel line TL by the lane trace control based on the target steering torque Tr*.

As a result, at a time point t4, the value of the steering angle θ is inverted from a positive value to a negative value. At this time point, the steering angle θ becomes an angle for departing from the object (that is, not an angle toward the object approach direction) with respect to the reference steering angle θre (=0). Thus, the driving support ECU 10 determines that the fourth condition is not satisfied (the own vehicle 100 is not steered so as to approach the another vehicle 120). In this case, the driving support ECU 10 stops the first correction control. That is, the driving support ECU 10 sets the value of the control gain Krc to “1”.

<Operation>

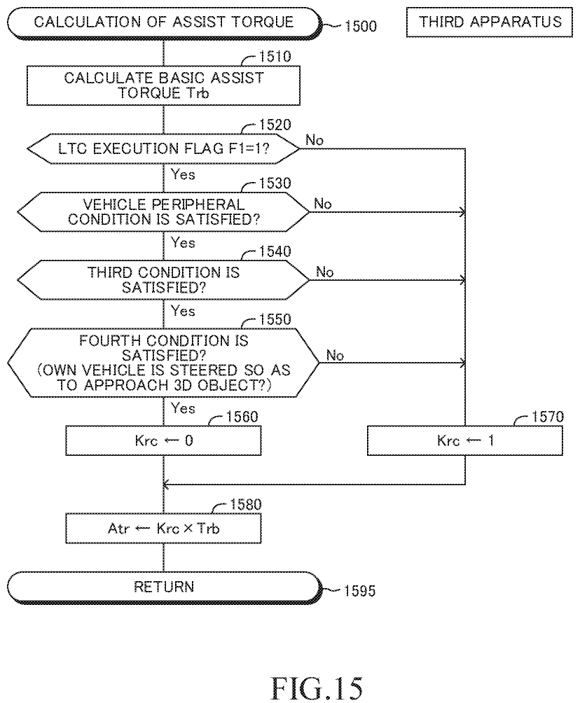

The third apparatus is different from the first apparatus in that the CPU of the driving support ECU 10 of the third apparatus (simply referred to as “CPU”) executes an “assist torque calculation routine illustrated as a flowchart in FIG. 15” in place of the routine of FIG. 10.

Thus, the CPU starts the processing from Step 1500 of FIG. 15 at a predetermined timing, and proceeds to Step 1510 to apply the steering torque Tra and the vehicle speed SPD to the lookup table Map2 (Tra, SPD), to thereby calculate the basic assist torque Trb.

Then, in Step 1520, the CPU determines whether or not the value of the LTC execution flag F1 is “1”.

When the value of the LTC execution flag F1 is not “1”, the CPU makes a determination of “No” in Step 1520, and proceeds to Step 1570 to set the value of the control gain Krc to “1”. Then, the CPU proceeds to Step 1580 to calculate the assist torque Atr (=Krc×Trb) as the second steering control amount. After that, the CPU proceeds to Step 1595 to temporarily finish this routine.

In contrast, when the value of the LTC execution flag F1 is “1”, the CPU makes a determination of “Yes” in Step 1520, and proceeds to Step 1530 to determine whether or not a predetermined vehicle peripheral condition is satisfied based on the vehicle peripheral information. The vehicle peripheral condition is satisfied when a 3D object exists around the own vehicle 100 (on the right side and/or the left side of the own vehicle 100).

When it is assumed that the vehicle peripheral condition is currently satisfied, the CPU makes a determination of “Yes” in Step 1530, and proceeds to Step 1540 to determine whether or not the predetermined third condition is satisfied. In this example, the third condition is satisfied when one or both of the following conditions 7 and 8 is satisfied.

(Condition 7) The distance dx1 in the road widthwise direction between the own vehicle 100 and a moving object is equal to or shorter than the predetermined second distance threshold value Dth2.
(Condition 8) The distance dx2 in the road widthwise direction between the own vehicle 100 and a fixed object is equal to or shorter than a “predetermined third distance threshold value Dth3 shorter than the second distance threshold value Dth2”.

The second distance threshold value Dth2 and the third distance threshold value Dth3 may be equal to each other.

The third condition may be a condition satisfied when a time to collision (TTC) between the own vehicle and a 3D object, which is obtained by “dividing a distance between the 3D object and the own vehicle by the relative speed of the 3D object”, is equal to or shorter than a predetermined time threshold value.

When it is assumed that the third condition is currently satisfied, the CPU makes a determination of “Yes” in Step 1540, and proceeds to Step 1550 to determine whether or not the predetermined fourth condition is satisfied. Specifically, the CPU uses the lookup table Map3 (CL, SPD) to calculate the reference steering angle θre. The CPU then determines whether or not the steering angle θ is an angle toward the object approach direction with respect to the reference steering angle θre. When the CPU determines that the steering angle θ is an angle toward the object approach direction with respect to the reference steering angle θre, the CPU determines that the own vehicle 100 is steered so that the own vehicle 100 approaches the 3D object (that is, determines that the fourth condition is satisfied).

It is assumed that the fourth condition is currently satisfied. In this case, the CPU makes a determination of “Yes” in Step 1550, and proceeds to Step 1560 to set the value of the control gain Krc to “0”. Then, the CPU proceeds to Step 1580 to calculate the assist torque Atr (=Krc×Trb) as the second steering control amount. In this case, the assist torque Atr becomes zero. After that, the CPU proceeds to Step 1595 to temporarily finish this routine.

Meanwhile, when the vehicle peripheral condition is not satisfied at a time point at which the CPU proceeds to Step 1530, the CPU makes a determination of “No” in Step 1530, and proceeds to Step 1570. Further, when the third condition is not satisfied at a time point at which the CPU proceeds to Step 1540, the CPU makes a determination of “No” in Step 1540, and proceeds to Step 1570. Additionally, when the fourth condition is not satisfied at a time point at which the CPU proceeds to Step 1550, the CPU makes a determination of “No” in Step 1550, and proceeds to Step 1570. When the CPU proceeds to Step 1570, the CPU sets the value of the control gain Krc to “1”. Then, the CPU proceeds to Step 1580 to calculate the assist torque Atr (=Krc×Trb) as the second steering control amount. After that, the CPU proceeds to Step 1595 to temporarily finish this routine.

As described above, when the third apparatus determines that the object approach condition is satisfied (that is, both the third condition and the fourth condition are satisfied) during the execution of the lane trace control, the third apparatus executes the first correction control of decreasing the assist torque Atr to zero. Thus, the torque control amount Trc immediately after the time point (time point t2) at which the object approach condition is satisfied is a value obtained by subtracting the assist torque Atr from the torque control amount Trc immediately before the time point (time point t2) at which the object approach condition is satisfied. That is, only the torque component (target steering torque Tr*) in the direction opposite to the acting direction of the assist torque remains in the torque control amount Trc. Thus, a relatively large torque in the direction (second direction) opposite to the operation by the driver is generated on the steering wheel SW, and the driver thus feels a large reaction force. The third apparatus can notify the driver of a state in which the own vehicle 100 has approached the 3D object through this reaction force.

Further, when the third apparatus determines that the own vehicle 100 is not steered so as to approach the 3D object (that is, the fourth condition is not satisfied) after the start of the first correction control, the third apparatus stops the first correction control. When the first correction control is stopped, the assist torque Atr is added to the torque control amount Trc, and thus the operation on the steering wheel SW by the driver is assisted. As a result, the driver can easily depart the own vehicle 100 from the 3D object.

The third apparatus can be applied also to a case in which the lane trace control is being executed under the state (b) or the state (c).

### Fourth Embodiment

A description is now given of a driving support apparatus (hereinafter sometimes referred to as “fourth apparatus”) according to a fourth embodiment. The fourth apparatus is different from the first apparatus in that the target steering torque Tr* is corrected when the own vehicle 100 has approached the white line. A description is now mainly given of this difference.

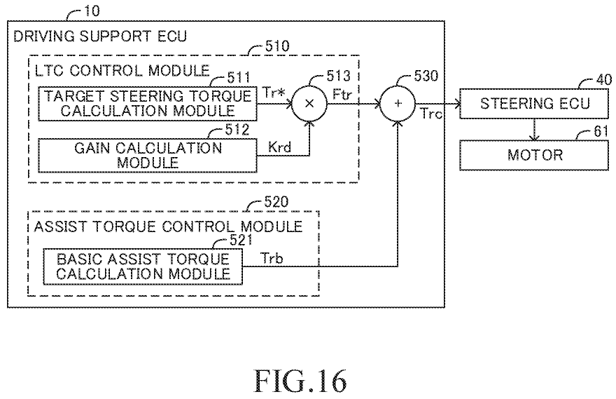

As illustrated in FIG. 16, the driving support ECU 10 of the fourth apparatus includes, from a functional viewpoint, an LTC control module 510, an assist torque control module 520, and an adder 530. In FIG. 16, the same components as the components illustrated in FIG. 5 are indicated by the same reference numerals of FIG. 5 indicating such components. Therefore, a detailed description is omitted for the components indicated by the same reference numerals as those of FIG. 5.

The LTC control module 510 includes a target steering torque calculation module 511, a gain calculation module 512, and a multiplier 513. The gain calculation module 512 calculates a control gain Krd based on the vehicle peripheral information, the steering angle θ, and the like. The multiplier 513 obtains a value (=Krd×Tr*) calculated by multiplying the target steering torque Tr* output from the target steering torque calculation module 511 and the control gain Krd output from the gain calculation module 512 by each other, and outputs this value to the adder 530 as final target steering torque Ftr. The target steering torque Ftr corresponds to an example of the “first steering control amount”.

The basic assist torque calculation module 521 calculates the basic assist torque Trb, and outputs the basic assist torque Trb to the adder 530.

The adder 530 obtains the torque control amount Trc (=Ftr+Trb), which is a value calculated by adding the target steering torque Ftr output from the LTC control module 510 and the basic assist torque Trb output from the assist torque control module 520 to each other, and outputs this torque control amount Trc to the steering ECU 40 as a final torque control amount.

<Operation>

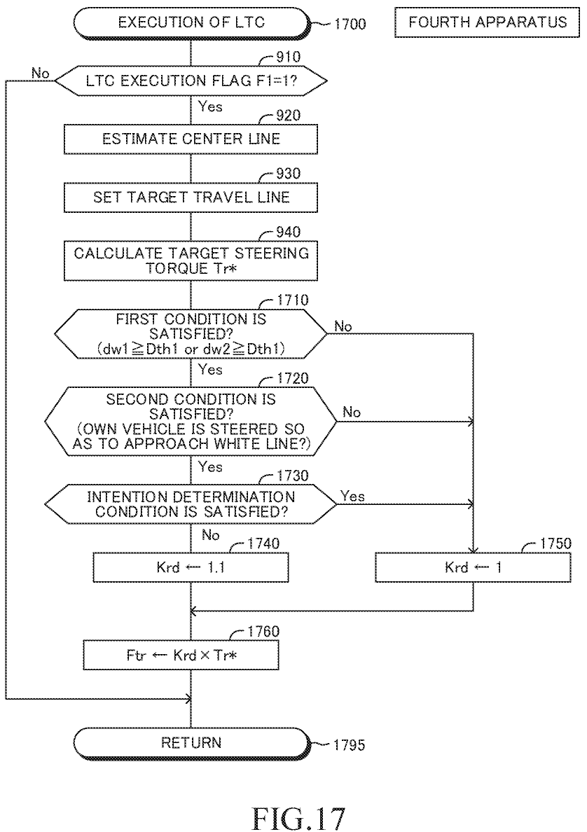

The fourth apparatus is different from the first apparatus in that the CPU of the driving support ECU 10 of the fourth apparatus (simply referred to as “CPU”) executes an “LTC execution routine illustrated as a flowchart in FIG. 17” in place of the routine of FIG. 9.

The routine illustrated in FIG. 17 is a routine obtained by adding Step 1710 to Step 1760 to the routine illustrated in FIG. 9. In FIG. 17, steps in which the same processing as that in the steps illustrated in FIG. 9 is executed are indicated by the same reference numerals of FIG. 9 indicating those steps. Therefore, a detailed description is omitted for the steps indicated by the same reference numerals as those of FIG. 9.

Thus, the CPU starts processing from Step 1700 of FIG. 17 at a predetermined timing. When the CPU proceeds to Step 1710 through Steps 910 to Step 940, the CPU determines whether or not the predetermined first condition is satisfied. The CPU determines whether or not the first condition is satisfied by executing processing similar to the processing in Step 1030 of the routine of FIG. 10.

When it is assumed that the first condition is currently satisfied, the CPU makes a determination of “Yes” in Step 1710, and proceeds to Step 1720 to determine whether or not the predetermined second condition is satisfied. The CPU determines whether or not the second condition is satisfied by executing processing similar to the processing in Step 1040 of the routine of FIG. 10.

When it is assumed that the second condition is currently satisfied, the CPU makes a determination of “Yes” in Step 1720, and proceeds to Step 1730 to determine whether or not the intention determination condition is satisfied. The CPU determines whether or not the intention determination condition is satisfied by executing processing similar to the processing in Step 1050 of the routine of FIG. 10.

When it is assumed that the intention determination condition is not currently satisfied, the CPU makes a determination of “No” in Step 1730, and proceeds to Step 1740 to set the value of the control gain Krd to a “value larger than 1 (for example, 1.1)”. Then, the CPU proceeds to Step 1760 to calculate the final target steering torque Ftr (=Krd×Tr*) as the first steering control amount. After that, the CPU proceeds to Step 1795 to temporarily finish this routine.

Meanwhile, when the first condition is not satisfied at a time point at which the CPU proceeds to Step 1710, the CPU makes a determination of “No” in Step 1710, and proceeds to Step 1750. Further, when the second condition is not satisfied at a time point at which the CPU proceeds to Step 1720, the CPU makes a determination of “No” in Step 1720, and proceeds to Step 1750. Further, when the intention determination condition is satisfied at a time point at which the CPU proceeds to Step 1730, the CPU makes a determination of “Yes” in Step 1730, and proceeds to Step 1750. When the CPU proceeds to Step 1750, the CPU sets the value of the control gain Krd to “1”. Then, the CPU proceeds to Step 1760 to calculate the final target steering torque Ftr (=Krd×Tr*) as the first steering control amount. After that, the CPU proceeds to Step 1795 to temporarily finish this routine.

Further, the CPU is different from the first apparatus in that only Step 1010 is executed in the routine of FIG. 10.

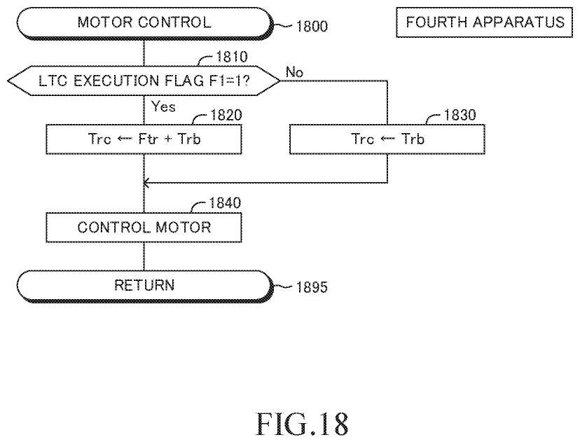

Further, the CPU is different from the first apparatus in that the CPU executes a “motor control routine illustrated in FIG. 18 as a flowchart” in place of the routine of FIG. 11. Thus, the CPU starts processing from Step 1800 of FIG. 18 at a predetermined timing, and proceeds to Step 1810 to determine whether or not the value of the LTC execution flag F1 is “1”.

When the value of the LTC execution flag F1 is “1”, the CPU makes a determination of “Yes” in Step 1810, and proceeds to Step 1820 to obtain a value (=Ftr+Trb) by adding the target steering torque Ftr and the basic assist torque Trb to each other and set this value as the final torque control amount Trc. Then, in Step 1840, the CPU controls the motor 61 based on the torque control amount Trc. After that, the CPU proceeds to Step 1895 to temporarily finish this routine.

In contrast, when the value of the LTC execution flag F1 is not “1”, the CPU makes a determination of “No” in Step 1810, and proceeds to Step 1830 to set the basic assist torque Trb as the final torque control amount Trc. Then, in Step 1840, the CPU controls the motor 61 based on the torque control amount Trc. After that, the CPU proceeds to Step 1895 to temporarily finish this routine.

As described above, when the fourth apparatus determines that the white-line approach condition is satisfied (that is, both the first condition and the second condition are satisfied) during the execution of the lane trace control, the fourth apparatus executes the control of increasing the magnitude of the target steering torque Ftr immediately after the specific time point at which the white-line approach condition is satisfied to be larger than the magnitude of the target steering torque Ftr immediately before this specific time point. This control can be considered that “the torque component toward the direction for approaching the target travel line TL is added to the torque control amount Trc immediately before the specific time point at which the white-line approach condition is satisfied”. Thus, this control corresponds to an example of the “first correction control”.

Thus, a relatively large torque in the direction (second direction) opposite to the operation of the driver is generated on the steering wheel SW immediately after the specific time point. As a result, the driver feels a reaction force against the operation on the steering wheel SW. The fourth apparatus can notify the driver that the own vehicle 100 is approaching the white line through the reaction force.

Further, when the fourth apparatus determines that the own vehicle 100 is not steered so as to approach the white line (that is, the second condition is not satisfied) after the start of the first correction control, the fourth apparatus stops the first correction control. For example, when the first correction control is continued under the state in which the driver is operating the steering wheel SW so as to return the own vehicle 100 to the target travel line TL, the own vehicle 100 is quickly returned toward the target travel line TL, and the own vehicle 100 may consequently pass beyond the target travel line TL (that is, may overshoot the target travel line TL). In contrast, when the fourth apparatus determines that the own vehicle 100 is not steered so as to approach the white line, the fourth apparatus stops the first correction control. Thus, the own vehicle 100 is gradually returned toward the target travel line TL. Thus, a possibility that the own vehicle 100 may pass beyond the target travel line TL can be reduced.

### Fifth Embodiment

A description is now given of a driving support apparatus (hereinafter sometimes referred to as “fifth apparatus”) according to a fifth embodiment. The fifth apparatus is different from the first apparatus in that the fifth apparatus calculates a torque component (a correction torque Mtr described below) in such a direction that the own vehicle 100 approaches the target travel line TL independently of the target steering torque Tr* and the assist torque Atr, and adds this correction torque to the torque control amount Trc. A description is now mainly given of this difference.

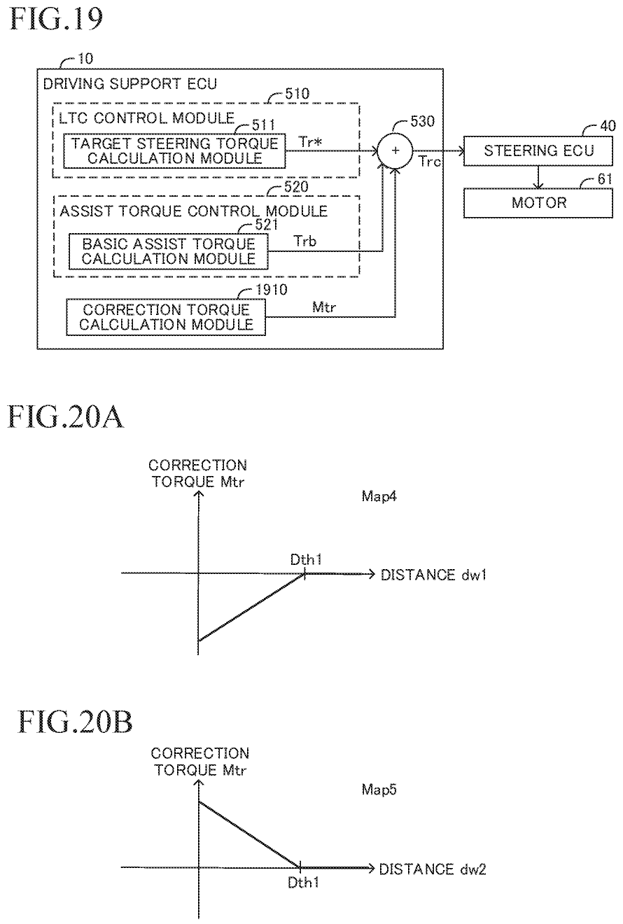

As illustrated in FIG. 19, the driving support ECU 10 of the fifth apparatus includes, from a functional viewpoint, the LTC control module 510, the assist torque control module 520, the adder 530, and a correction torque calculation module 1910. In FIG. 19, the same components as the components illustrated in FIG. 5 are indicated by the same reference numerals of FIG. 5 indicating such components. Therefore, a detailed description is omitted for the components indicated by the same reference numerals as those of FIG. 5.

When a difference (dw1−dw2) of the first distance dw1 from the second distance dw2 is smaller than zero (that is, dw1<dw2), the correction torque calculation module 1910 applies the first distance dw1 to a lookup table Map4 (dw1) shown in FIG. 20A, to thereby calculate a correction torque Mtr. In the lookup table Map4, a magnitude of the correction torque Mtr having a negative value increases as the first distance dw1 decreases. Further, when the first distance dw1 exceeds a predetermined value (that is, the first distance threshold value Dth1), the correction torque Mtr becomes zero. The lookup table Map4 is stored in the ROM 10c.

When the difference (dw1−dw2) of the first distance dw1 from the second distance dw2 is equal to or larger than zero (that is, dw1≥dw2), the correction torque calculation module 1910 applies the second distance dw2 to a lookup table Map5 (dw2) shown in FIG. 20B, to thereby calculate the correction torque Mtr. In the lookup table Map5, a magnitude of the correction torque Mtr having a positive value increases as the second distance dw2 decreases. Further, when the second distance dw2 exceeds a predetermined value (that is, the first distance threshold value Dth1), the correction torque Mtr becomes zero. The lookup table Map5 is stored in the ROM 10c. The correction torque calculation module 1910 outputs the correction torque Mtr to the adder 530.

The adder 530 calculates a value (=Tr*+Trb+Mtr) obtained by adding the target steering torque Tr* output from the LTC control module 510, the basic assist torque Trb output from the assist torque control module 520, and the correction torque Mtr output from the correction torque calculation module 1910 to one another. The adder 530 outputs the value to the steering ECU 40 as the final control amount Trc. The steering ECU 40 controls the current caused to flow through the motor 61 in accordance with the torque control amount Trc.

<Operation>

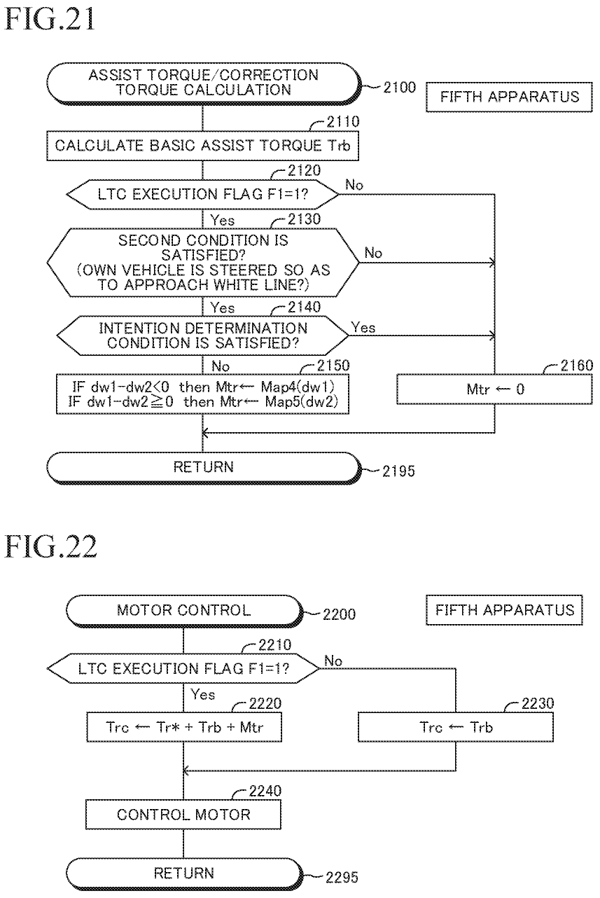

The fifth apparatus is different from the first apparatus in that the CPU of the driving support ECU 10 of the fifth apparatus (simply referred to as “CPU”) executes an “assist torque/correction torque calculation routine illustrated as a flowchart in FIG. 21” in place of the routine of FIG. 10”.

Thus, the CPU starts the processing from Step 2100 of FIG. 21 at a predetermined timing, and proceeds to Step 2110 to apply the steering torque Tra and the vehicle speed SPD to the lookup table Map2 (Tra, SPD), to thereby calculate the basic assist torque Trb.

Then, in Step 2120, the CPU determines whether or not the value of the LTC execution flag F1 is “1”.

When the value of the LTC execution flag F1 is not “1”, the CPU makes a determination of “No” in Step 2120, and proceeds to Step 2160 to set the value of the correction torque Mtr to “0”. After that, the CPU proceeds to Step 2195 to temporarily finish this routine.

In contrast, when the value of the LTC execution flag F1 is “1”, the CPU makes a determination of “Yes” in Step 2120, and proceeds to Step 2130 to determine whether or not the second condition is satisfied. The CPU determines whether or not the second condition is satisfied by executing processing similar to the processing in Step 1040 of the routine of FIG. 10.

When it is assumed that the second condition is currently satisfied, the CPU makes a determination of “Yes” in Step 2130, and proceeds to Step 2140 to determines whether or not the intention determination condition is satisfied. The CPU determines whether or not the intention determination condition is satisfied by executing processing similar to the processing in Step 1050 of the routine of FIG. 10.

When it is assumed that the intention determination condition is not currently satisfied, the CPU makes a determination of “No” in Step 2140, and proceeds to Step 2150 to calculate the correction torque Mtr. Specifically, when the difference (dw1−dw2) of the first distance dw1 from the second distance dw2 is smaller than zero, the CPU applies the first distance dw1 to the lookup table Map4 (dw1), to thereby calculate the correction torque Mtr. Meanwhile, when the difference (dw1−dw2) of the first distance dw1 from the second distance dw2 is equal to or larger than zero, the CPU applies the second distance dw2 to the lookup table Map5 (dw2), to thereby calculate the correction torque Mtr. After that, the CPU proceeds to Step 2195 to temporarily finish this routine.

Meanwhile, when the second condition is not satisfied at a time point at which the CPU proceeds to Step 2130, the CPU makes a determination of “No” in Step 2130, and proceeds to Step 2160. Further, when the intention determination condition is satisfied at a time point at which the CPU proceeds to Step 2140, the CPU makes a determination of “Yes” in Step 2140, and proceeds to Step 2160. When the CPU proceeds to Step 2160, the CPU sets the value of the correction torque Mtr to “0”. After that, the CPU proceeds to Step 2195 to temporarily finish this routine.

Further, the CPU is different from the first apparatus in that the CPU executes a “motor control routine illustrated in FIG. 22 as a flowchart” in place of the routine of FIG. 11. Thus, the CPU starts processing from Step 2200 of FIG. 22 at a predetermined timing, and proceeds to Step 2210 to determine whether or not the value of the LTC execution flag F1 is “1”.

When the value of the LTC execution flag F1 is “1”, the CPU makes a determination of “Yes” in Step 2210, and proceeds to Step 2220 to obtain a value by adding the target steering torque Tr*, the basic assist torque Trb, and the correction torque Mtr to one another, and sets this value as the final torque control amount Trc. Then, in Step 2240, the CPU controls the motor 61 based on the torque control amount Trc. After that, the CPU proceeds to Step 2295 to temporarily finish this routine.

In contrast, when the value of the LTC execution flag F1 is not “1”, the CPU makes a determination of “No” in Step 2210, and proceeds to Step 2230 to set the basic assist torque Trb as the final torque control amount Trc. Then, in Step 2240, the CPU controls the motor 61 based on the torque control amount Trc. After that, the CPU proceeds to Step 2295 to temporarily finish this routine.

As described above, when the own vehicle 100 is steered so as to approach any one of the left and right white lines during the execution of the lane trace control, the fifth apparatus calculates the correction torque (the torque component in such a direction that the own vehicle 100 approaches the target travel line TL) Mtr in accordance with the distance between the own vehicle 100 and the white line, and adds the correction torque Mtr to the torque control amount Trc. Thus, the “torque control amount Trc immediately after a specific time point at which the own vehicle 100 approaches the white line (time point at which the shorter distance out of the first distance dw1 and the second distance dw2 becomes equal to or shorter than the first distance threshold value Dth1)” is the value obtained by adding the torque component (correction torque Mtr) in such a direction that the own vehicle 100 approaches the target travel line TL to the torque control amount Trc immediately before the specific time point. Thus, this control corresponds to an example of the “first correction control”. As a result, a relatively large torque in the direction (second direction) opposite to the operation of the driver is generated on the steering wheel SW immediately after the specific time point. Therefore, the driver feels a reaction force against the operation on the steering wheel SW. The fifth apparatus can notify the driver that the own vehicle 100 is approaching the white line through the reaction force.

Further, the fifth apparatus increases the magnitude of the correction torque Mtr as the distance between the own vehicle 100 and the white line decreases. When the distance between the own vehicle 100 and the white line decreases, a relatively large torque in the direction (second direction) opposite to the operation by the driver is generated on the steering wheel SW, and the driver thus feels a large reaction force. The fifth apparatus can notify the driver of a degree of the approach of the own vehicle 100 to the white line through the use of that change in the magnitude of the reaction force.

The present disclosure is not limited to the embodiments described above, and various modification examples can be adopted within the scope of the present disclosure.

### Modification Example 1

The white-line approach condition may be a condition satisfied when any one of the following conditions 9 and 10 is satisfied.

(Condition 9): The own vehicle 100 is positioned on the left side of the target travel line TL, and a speed (a relative speed in the road widthwise direction) Va1 at which the own vehicle 100 approaches the left white line LL is equal to or higher than a predetermined relative speed threshold value Vth.
(Condition 10): The own vehicle 100 is positioned on the right side of the target travel line TL, and a speed (a relative speed in the road widthwise direction) Va2 at which the own vehicle 100 approaches the right white line RL is equal to or higher than the predetermined relative speed threshold value Vth.

### Modification Example 2

The object approach condition may be a condition satisfied when one or more of the following conditions 11 to 14 is satisfied.

(Condition 11) A speed (a relative speed in the road widthwise direction) Vb1 at which the own vehicle 100 approaches a moving object is equal to or higher than a predetermined first relative speed threshold value Vrh1 under a state in which the moving object exists on the left side of the own vehicle 100, and the own vehicle 100 is positioned on the left side of the target travel line TL.
(Condition 12) The speed (relative speed in the road widthwise direction) Vb1 at which the own vehicle 100 approaches a moving object is equal to or higher than the predetermined first relative speed threshold value Vrh1 under a state in which the moving object exists on the right side of the own vehicle 100, and the own vehicle 100 is positioned on the right side of the target travel line TL.
(Condition 13) A speed (a relative speed in the road widthwise direction) Vb2 at which the own vehicle 100 approaches a fixed object is equal to or higher than a predetermined second relative speed threshold value Vrh2 under a state in which the fixed object exists on the left side of the own vehicle 100, and the own vehicle 100 is positioned on the left side of the target travel line TL.
(Condition 14) The speed (relative speed in the road widthwise direction) Vb2 at which the own vehicle 100 approaches a fixed object is equal to or higher than the predetermined second relative speed threshold value Vrh2 under a state in which the fixed object exists on the right side of the own vehicle 100, and the own vehicle 100 is positioned on the right side of the target travel line TL.

The first relative speed threshold value Vrh1 and the second relative speed threshold value Vrh2 may be equal to each other or different from each other.

### Modification Example 3

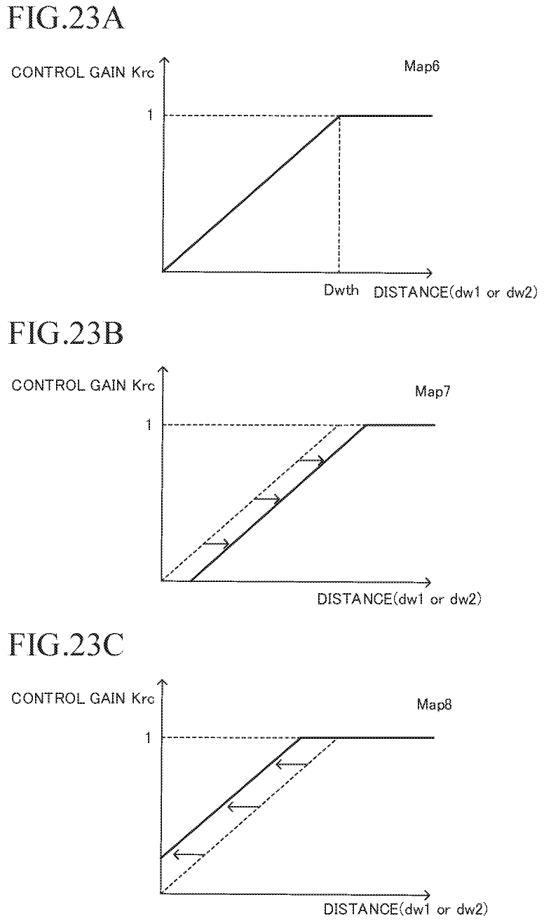

The driving support ECU 10 may change the value of the control gain Krc in accordance with the magnitude of the first distance dw1 or the second distance dw2. For example, when the difference (dw1−dw2) of the first distance dw1 from the second distance dw2 is smaller than zero (dw1<dw2), the CPU may apply the first distance dw1 to a lookup table Map6 shown in FIG. 23A, to thereby calculate the control gain Krc. Further, when the difference (dw1−dw2) of the first distance dw1 from the second distance dw2 is equal to or larger than zero (dw1≥dw2), the CPU may apply the second distance dw2 to the lookup table Map6, to thereby calculate the control gain Krc. In the lookup table Map6, when the first distance dw1 or the second distance dw2 becomes shorter than a threshold value Dwth (for example, the first distance threshold value Dth1) (that is, a predetermined approach condition is satisfied), the value of the control gain Krc becomes a “value less than 1”. Moreover, as the first distance dw1 or the second distance dw2 decreases, the value of the control gain Krc decreases.

Further, the driving support ECU 10 may use the lookup table Map6 shown in FIG. 23A to calculate the control gain Krc when the approach speed (relative speed (Va1, Va2)) of the own vehicle 100 in the road widthwise direction is equal to or lower than a predetermined first approach speed. Meanwhile, when the approach speed (relative speed (Va1, Va2)) is higher than the predetermined first approach speed, the driving support ECU 10 may use a lookup table Map7 shown in FIG. 23B to calculate the control gain Krc. The lookup table Map7 is a lookup table obtained by translating the lookup table Map6 toward the positive direction in parallel with the x axis. The lookup table Map7 is stored in the ROM 10c. With this configuration, when the relative speed (Va1, Va2) has a large value, and the own vehicle 100 is thus likely to approach the white line relatively earlier, it is possible to apply the reaction force to the driver at an earlier stage.

Further, the driving support ECU 10 may use the lookup table Map6 shown in FIG. 23A to calculate the control gain Krc when the approach speed (relative speed (Va1, Va2)) of the own vehicle 100 in the road widthwise direction is equal to or higher than a predetermined second approach speed. Meanwhile, when the approach speed (relative speed (Va1, Va2)) is lower than the predetermined second approach speed, the driving support ECU 10 may use a lookup table Map8 shown in FIG. 23C to calculate the control gain Krc. The second approach speed is a speed lower than the first approach speed. The lookup table Map8 is a lookup table obtained by translating the lookup table Map6 toward the negative direction in parallel with the x axis. The lookup table Map8 is stored in the ROM 10c. With this configuration, when the relative speed (Va1, Va2) has a relatively small value, and the own vehicle 100 is thus less likely to approach the white line, it is possible to delay the timing at which the reaction force is applied to the driver.

The above-mentioned lookup table (Map6, Map7, or Map8) may be applied to the third apparatus. The driving support ECU 10 of the third apparatus may apply the distance dx1 between the own vehicle 100 and a moving object in the road widthwise direction or the distance dx2 between the own vehicle 100 and a fixed object in the road widthwise direction to the lookup table (Map6, Map7, or Map8), to thereby calculate the control gain Krc.

### Modification Example 4

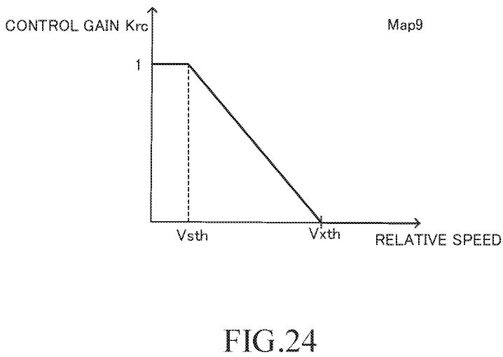

When the condition 9 or the condition 10 is satisfied, the driving support ECU 10 may apply a speed (that is, the relative speed (Va1, Va2)) at which the own vehicle 100 approaches the white line in the road widthwise direction to a lookup table Map9 shown in FIG. 24, to thereby calculate the control gain Krc.

Similarly, when one or more of the conditions 11 to 14 is satisfied, the driving support ECU 10 may apply a speed (that is, the relative speed (Vb1, Vb2)) at which the own vehicle 100 approaches the 3D object in the road widthwise direction to the lookup table Map9 shown in FIG. 24, to thereby calculate the control gain Krc.

The threshold value Vsth in the lookup table Map9 may be set to a value equal to any one of the relative speed threshold value Vth, the first relative speed threshold value Vrh1, and the second relative speed threshold value Vrh2.

In the lookup table Map9, when the relative speed (Va1, Va2, Vb1, or Vb2) exceeds the predetermined threshold value Vsth (that is, when the predetermined approach condition is satisfied), the value of the control gain Krc becomes a “value less than 1”. Further, as the relative speed increases, the value of the control gain Krc decreases. When the relative speed becomes higher than the predetermined value Vxth, the control gain Krc becomes zero. The lookup table Map9 is stored in the ROM 10c.

### Modification Example 5

The driving support ECU 10 may employ a value obtained by multiplying the control gain Krc obtained as described above by a “first gain Km1” as the final control gain Krc. The first gain Km1 is a value that is larger than 0 and equal to or less than 1. The first gain Km1 decreases as the vehicle speed SPD increases. For example, when the vehicle speed SPD is higher than a predetermined first speed threshold value, the driving support ECU 10 may set the first gain Km to a “value less than 1”, and employ a value obtained by multiplying the control gain Krc by the first gain Km1 as the final control gain Krc. Further, when the vehicle speed SPD is equal to or lower than the predetermined first speed threshold value, the driving support ECU 10 may set the first gain Km1 to “1”, and employ a value obtained by multiplying the control gain Krc by the first gain Km1 as the final control gain Krc.

### Modification Example 6

The driving support ECU 10 may employ a value obtained by multiplying the control gain Krc obtained as described above by a “second gain Km2” as the final control gain Krc. The second gain Km2 is a value that is larger than 0 and equal to or less than 1. The second gain Km2 decreases as the curvature of the travel lane increases. For example, when the curvature of the travel lane is larger than a predetermined first curvature threshold value, the driving support ECU 10 may set the second gain Km2 to a “value less than 1”, and employ a value obtained by multiplying the control gain Krc by the second gain Km2 as the final control gain Krc. Further, when the curvature of the travel lane is equal to or smaller than the predetermined first curvature threshold value, the driving support ECU 10 may set the second gain Km2 to “1”, and employ a value obtained by multiplying the control gain Krc by the second gain Km2 as the final control gain Krc.

### Modification Example 7

In Step 1040 of the routines of FIG. 10 and FIG. 13, the CPU may use the value of the steering torque Tra to determine whether or not the second condition is satisfied (whether or not the own vehicle 100 is steered so as to approach the white line). The CPU determines whether or not the steering torque Tra is a torque in the lane-deviation direction with respect to the reference steering torque (for example, the target steering torque Tr*). In the example of FIG. 6, the own vehicle 100 is traveling in the straight travel lane 610, and it is thus assumed that the reference steering torque (target steering torque Tr) is “0”. Thus, the CPU determines that the steering torque Tra is a torque toward the lane-deviation direction when the steering torque Tra has a positive value in the case in which the first distance dw1 is equal to or shorter than the first distance threshold value Dth1. In this case, the CPU determines that the second condition is satisfied.

### Modification Example 8

In Step 1310 of the routine of FIG. 13, the reference steering torque Tre may be set to “0”. As another example, the reference steering torque Tre may be set to the same magnitude as that of the target steering torque Tr*.

As still another example, in Step 1310 of the routine of FIG. 13, the CPU may determine whether or not the driver is operating the steering wheel SW based on a signal from a touch sensor built into the steering wheel SW and/or image data from a camera sensor provided in a vehicle cabin.

### Modification Example 9

The configuration in the third apparatus may be applied to other apparatus (the second apparatus, the fourth apparatus, and the fifth apparatus). That is, in other apparatus (the second apparatus, the fourth apparatus, and the fifth apparatus), the torque component in such a direction that the own vehicle 100 approaches the target travel line TL may be added to the torque control amount Trc in accordance with the distance between the own vehicle 100 and a 3D object.

### Modification Example 10

In the first apparatus to the fifth apparatus, the lane trace control is executed only while the adaptive cruise control (ACC) is being executed, but the lane trace control may be executed even while the adaptive cruise control is not being executed.

What is claimed is:

1. A driving support apparatus, comprising:
a steering mechanism configured to mechanically couple a steering wheel and a steered wheel to each other;
a motor, which is provided in the steering mechanism, and is configured to generate a torque for changing a steered angle of the steered wheel;
an information acquisition device configured to acquire vehicle peripheral information, the vehicle peripheral information including information on a partition line around an own vehicle and information on an object existing around the own vehicle;
a first calculator configured to calculate a first steering control amount for causing the own vehicle to travel along a target travel line set in a travel lane, which is a lane in which the own vehicle is traveling, based on the vehicle peripheral information;
a second calculator configured to calculate a second steering control amount for assisting an operation on the steering wheel by a driver in accordance with the operation on the steering wheel; and
a steering controller configured to calculate a torque control amount based on at least the first steering control amount and the second steering control amount, and drive the motor based on the torque control amount,
wherein the steering controller is configured to:
determine, when the driver has operated the steering wheel, whether a predetermined approach condition is satisfied based on at least the vehicle peripheral information, the predetermined approach condition being a condition which is satisfied when it is estimated that the own vehicle has approached any one of a partition line defining the travel lane and the object as a result of the operation on the steering wheel; and
execute, when it is determined that the predetermined approach condition is satisfied, first correction control of correcting the torque control amount so that the torque control amount immediately after a first specific time point, at which it is determined that the predetermined approach condition is satisfied, becomes a value obtained by changing the torque control amount immediately before the first specific time point by a torque component in such a direction that the own vehicle approaches the target travel line.

2. The driving support apparatus according to claim 1, wherein the steering controller is configured to:
determine whether the own vehicle is steered so that the own vehicle approaches any one of the partition line and the object after the execution of the first correction control is started; and
stop the first correction control when it is determined that the own vehicle is not steered so as to approach any one of the partition line and the object.

3. The driving support apparatus according to claim 2, wherein the steering controller is configured to:
determine whether the driver is operating the steering wheel after it is determined that the own vehicle is not steered so as to approach any one of the partition line and the object;
execute, when it is determined that the driver is operating the steering wheel, second correction control so that a magnitude of the second steering control amount at a second specific time point on and after it is determined that the driver is operating the steering wheel becomes a value larger than a magnitude of a basic assist control amount corresponding to the operation on the steering wheel at the second specific time point; and
stop the second correction control when it is determined that the driver is not operating the steering wheel after the second correction control is started.

4. The driving support apparatus according to claim 1, wherein the steering controller is configured to execute the first correction control so that a magnitude of the second steering control amount immediately after the first specific time point becomes smaller than a magnitude of the second steering control amount immediately before the first specific time point.

5. The driving support apparatus according to claim 1, wherein the steering controller is configured to execute the first correction control so that a magnitude of the first steering control amount immediately after the first specific time point becomes larger than a magnitude of the first steering control amount immediately before the first specific time point.

6. The driving support apparatus according to claim 1, wherein the steering controller is configured to change a magnitude of the torque component in such a direction that the own vehicle approaches the target travel line in accordance with at least one of: a distance between the own vehicle and any one of the partition line and the object; or a speed at which the own vehicle approaches any one of the partition line and the object, to thereby execute the first correction control.
